(19) United States
(12) Patent Application Publication
(10) Pub. No.: US 2024/0241366 A1
(43) Pub. Date: Jul. 18, 2024

(54) LARGE FOV OPTICAL METASURFACE SYSTEMS

(71) Applicant: Lumotive, Inc., Redmond, WA (US)

(72) Inventors: Gleb M. Akselrod, Kenmore, WA (US); Matthieu Saracco, Woodinville, WA (US); Apurva Jain, Lynwood, WA (US); Ross D. Uthoff, Seattle, WA (US)

(21) Appl. No.: 18/414,236

(22) Filed: Jan. 16, 2024

Related U.S. Application Data
(60) Provisional application No. 63/480,097, filed on Jan. 16, 2023.

(51) Int. Cl. G02B 26/08; B82Y 20/00; G01S 7/481; G02B 1/00; G02B 3/02

(52) U.S. Cl. CPC G02B 26/0825; G01S 7/4814; G01S 7/4817; G02B 1/002; G02B 3/02; B82Y 20/00; G02B 2207/101

(57) ABSTRACT

A tunable optical metasurface may be steered to various steering angles. The field of view (FOV) in a first steering direction may be limited by the performance of an optically transparent cover of the metasurface and/or an anti-reflective coating applied thereto. Although the metasurface itself may be steerable to angles outside of the FOV, the transmissivity may be below an acceptable transmittance value. A biconic freeform optic is positioned within the optical path of the metasurface to expand the effective FOV. In some examples, the biconic freeform optic includes a concave first surface located nearest to the metasurface and a biconic second surface. The biconic second surface of the metasurface has a first radius of curvature along the first steering direction and a second radius of curvature along the non-steering direction or second steering direction.

### RELATED APPLICATIONS

This application claims the benefit of and priority to U.S. Provisional Patent Application No. 63/480,097, filed on Jan. 16, 2023, titled “Large Field-of-View Metasurface Optical Systems,” which application is hereby incorporated by reference in its entirety.

### TECHNICAL FIELD

This disclosure relates to optical metasurfaces and sensor systems, such as light detection and ranging (lidar) systems. This disclosure also relates to optical elements, such as lenses, mirrors, and prisms.

### BRIEF DESCRIPTION OF THE DRAWINGS

FIG. 1 illustrates a block diagram of a metasurface with input and output beams, according to one embodiment.

FIG. 2A illustrates an example graph of Fresnel losses of uncoated glass for optical radiation at various angles of incidence, according to one embodiment.

FIG. 2B illustrates an example graph of reflectance with respect to the angle of incidence for Thorlabs B-coating, according to one embodiment.

FIG. 3A illustrates a block diagram from a side view in the steering direction of a metasurface with a prism and a biconic freeform optic, according to one embodiment.

FIG. 3B illustrates a block diagram from a side view in the non-steering direction of the metasurface, prism, and freeform optic, according to one embodiment.

FIG. 3C illustrates a block diagram of a perspective view of the metasurface, prism, and freeform optic, according to one embodiment.

FIG. 4A illustrates a block diagram of a first perspective view of an example biconic freeform optic, according to one embodiment.

FIG. 4B illustrates a block diagram of a second perspective view of the example freeform optic, according to one embodiment.

FIG. 4C illustrates a block diagram of a third perspective view of the example freeform optic, according to one embodiment.

FIG. 4D illustrates a block diagram from a side view in the non-steering direction of the example freeform optic, according to one embodiment.

FIG. 4E illustrates a block diagram from a side view in the steering direction of the example freeform optic, according to one embodiment.

FIG. 4F illustrates a block diagram from a top view of the example freeform optic, according to one embodiment.

FIG. 4G illustrates a block diagram from a bottom view of the example freeform optic, according to one embodiment.

FIG. 5A illustrates a block diagram of a perspective view of an example freeform optic for a two-dimensionally steerable metasurface, according to one embodiment.

FIG. 5B illustrates a block diagram from a side view in a first steering direction of the example freeform optic for the two-dimensionally steerable metasurface, according to one embodiment.

FIG. 5C illustrates a block diagram from a side view in a second steering direction of the example freeform optic for the two-dimensionally steerable metasurface, according to one embodiment.

FIG. 6 illustrates a table of features and characteristics of various vertical-cavity surface-emitting lasers (VCSEL) and various edge-emitter lasers, according to one embodiment.

FIG. 7A illustrates example line beams of a metasurface with a freeform optic in a spherical coordinate system, according to one embodiment.

FIG. 7B illustrates the line beams in a cartesian coordinate system projected on a wall, according to one embodiment.

FIG. 7C illustrates cross-sections of the line beams in the non-steering direction, according to one embodiment.

FIG. 8A illustrates an optical layout view of a biconic freeform optic with spherical radii of curvature, according to one embodiment.

FIG. 8B illustrates line beams of the metasurface and freeform optic with the spherical radii of curvature of FIG. 8A, according to one embodiment.

FIG. 8C illustrates an optical layout view of a biconic freeform optic with radii of curvature with different conic constants, according to various embodiments.

FIG. 8D illustrates line beams of the metasurface and freeform optic with the radii of curvature with different conic constants of FIG. 8C, according to one embodiment.

FIG. 8E illustrates an optical layout view of a freeform optic with an extended polynomial surface, according to one embodiment.

FIG. 9A illustrates an example optical layout of a metasurface with a coupling prism and a freeform optic, according to one embodiment.

FIG. 9B illustrates another example optical layout of a metasurface with a coupling prism and a freeform optic, according to one embodiment.

FIG. 9C illustrates another example optical layout of a metasurface with a coupling prism and a freeform optic, according to one embodiment.

FIG. 9D illustrates another example optical layout of a metasurface with a coupling prism and a freeform optic, according to one embodiment.

FIG. 10A illustrates an example optical layout of a metasurface and a freeform optic separated by free space (air), according to one embodiment.

FIG. 10B illustrates another example optical layout of a metasurface and a freeform optic separated by free space, according to one embodiment.

FIG. 10C illustrates an example optical layout of a metasurface, a waveguide, and a freeform optic, according to one embodiment.

FIG. 11A illustrates a block diagram of a transmitter with a metasurface and a freeform optic to steer optical radiation to steering angles with an expanded field of view (FOV), according to one embodiment.

FIG. 11B illustrates a block diagram of a receiver with a metasurface and a freeform optic to de-steer the optical radiation onto a detector, according to one embodiment.

FIG. 12 illustrates a block diagram of a metasurface with a freeform optic and an optical diffuser to modify the angular profile in the steering and/or non-steering direction, according to one embodiment.

### DETAILED DESCRIPTION

Previous approaches to optical systems have involved the use of fixed optical elements to manipulate light propagation and achieve desired optical effects. These fixed optical elements, such as lenses and mirrors, have limitations in terms of their ability to steer light and adapt to changing optical conditions. Scanner-based three-dimensional sensing systems, such as light detection and ranging (lidar) devices, that utilize fixed optical elements often incorporate mechanical movement that limits the operation, speed, and longevity of such devices. The field of view (FOV) of scanner-based three-dimensional sensing systems is often limited by mechanical constraints. For example, devices that utilize microelectromechanical (MEM) scanners usually have a FOV that is less than 60 degrees.

One approach to address these limitations has been the development of tunable optical metasurfaces. A metasurface may for example, include an array of subwavelength structures that can manipulate the phase, amplitude, and/or polarization of light. By controlling the properties of these subwavelength structures, the metasurface can selectively steer light to different angles.

Examples of metasurfaces include one-dimensionally steerable metasurfaces and two-dimensionally steerable metasurfaces. A dynamically tunable one-dimensionally steerable metasurface may be selectively steered to various steering angles within a first FOV in the steering direction (e.g., 100-140 degrees) and have a second, fixed FOV in the non-steering direction (e.g., 10-30 degrees). A dynamically tunable two-dimensionally steerable metasurface may be selectively steered to various steering angles within a first FOV in a first steering direction and selectively steered to various steering angles within a second FOV in a second steering direction. The first and second fields of view (FOVs) may be the same or different.

As described in greater detail in the patents and patent applications incorporated herein by reference below, a metasurface may be steered by applying a pattern or patterns of voltage differentials across liquid crystal deposited between arrays of metasurface elements (e.g., one-dimensional arrays of metal rails or two-dimensional arrays of metal pillars). Liquid crystal metasurfaces (LCMs) may be fabricated in a complementary metal-oxide-semiconductor (CMOS) foundry. As an example, a FOV of a one-dimensionally steerable LCM may have a steering FOV of 140 degrees in a steering direction (e.g., steerable in a steering direction to −70 degrees and +70 degrees in a steering direction) and have a static FOV of between 10 and 30 degrees in the non-steering direction (e.g., −10 degrees to +10 degrees for a 20-degree FOV in the non-steering direction).

The LCM may be physically capable of scanning beyond 140 degrees in the steering direction. For example, the LCM may be physically capable of scanning all the way up to 180 degrees (-−/+90 deg). However, the useful or effective FOV may be limited due to the optical performance limitations of an optically transparent cover of the LCM and/or an anti-reflective (AR) coating applied thereto.

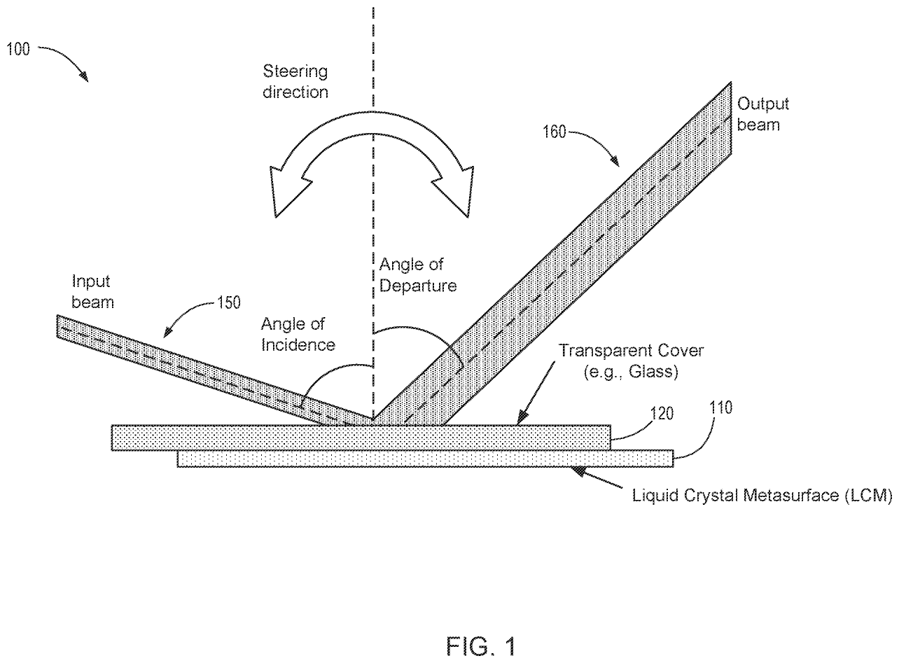

FIG. 1 illustrates a block diagram 100 of a metasurface 110 (e.g., an LCM) with an input beam 150 incident on the metasurface 110 at an angle of incidence and an output beam 160 is deflected (e.g., diffracted and/or reflected) at an angle of departure, according to one embodiment. As illustrated, the metasurface 110 includes a transparent cover 120 (e.g., a glass cover). The block diagram 100 is not drawn to scale. Optical polarization-dependent loss occurs at the interface of the transparent cover 120 and the air. The glass/air optical polarization-dependent loss is referred to as the Fresnel Reflection.

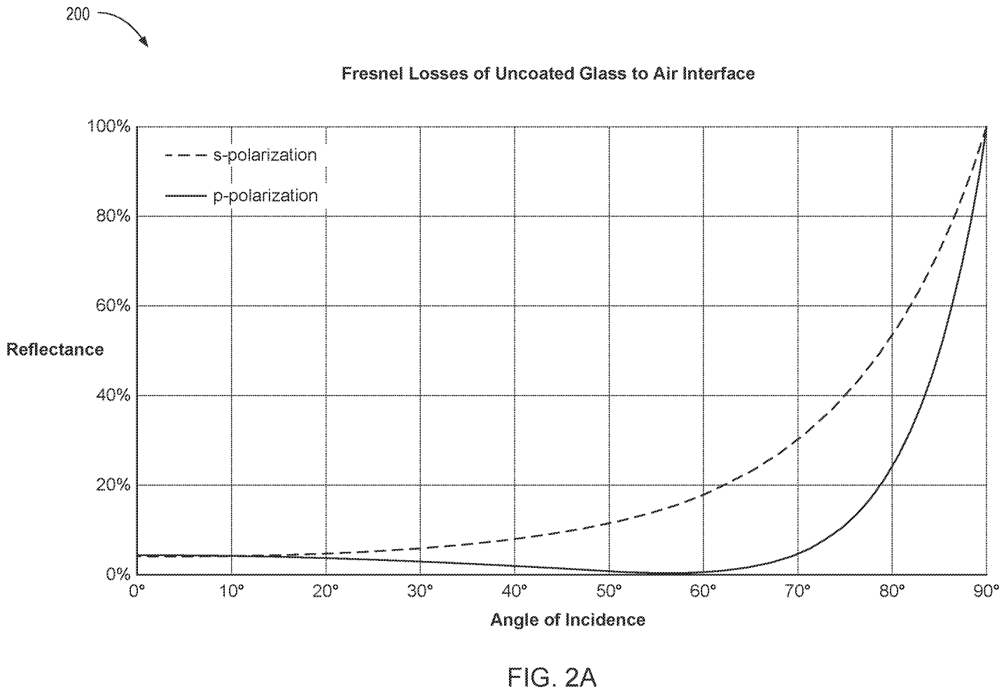

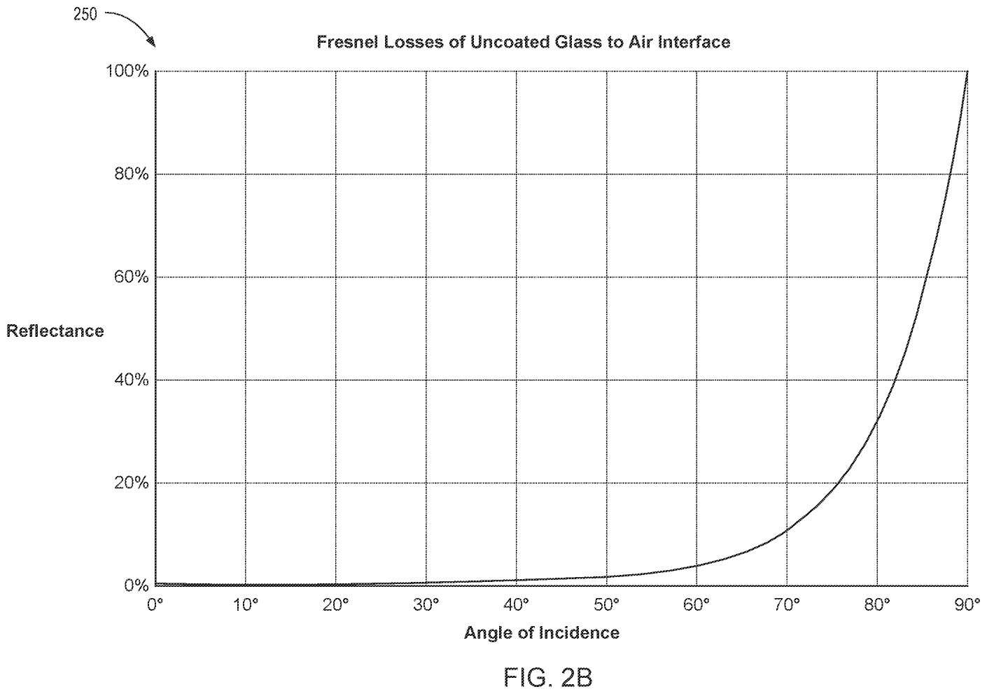

FIG. 2A illustrates an example graph 200 of Fresnel losses of uncoated glass for optical radiation at various angles of incidence, according to one embodiment. The percentage of optical radiation that is reflected or lost (reflectance percentage) is presented on the vertical axis, and the angle of incidence is presented on the horizontal axis. The graph 200 provides an example of the Fresnel losses of optical radiation with a wavelength of 852 nanometers between uncoated glass (n=1.5028) and air, according to one embodiment. In various embodiments, an anti-reflective coating is applied to the glass or other optically transparent cover.

FIG. 2B illustrates an example graph 250 of Fresnel losses of glass coated with an anti-reflective coating for optical radiation at various angles of incidence, according to one embodiment. The example graph 250 is provided for Thorlabs B-coating, but it is appreciated that any of a wide variety of anti-reflective coatings exhibit similar reflectance properties. Again, the percentage of optical radiation that is reflected or lost (reflectance percentage) is presented on the vertical axis, and the angle of incidence is presented on the horizontal axis. The reflectance varies with the angle of incidence (or angle of departure) of the optical radiation at the interface between the air and the anti-reflective coating.

Notably, the reflectance or Fresnel losses increase significantly at angles above approximately 70 degrees (e.g., >10% loss). Accordingly, a lidar or other sensing system that steers optical radiation to angles greater than approximately 70 degrees in either direction (e.g., a FOV of 140 degrees) experiences a loss in intensity in the output beam, which may cause a drop in performance (e.g., loss of range, ghost images, stray light, etc.). Thus, while a given metasurface may be physically steerable to a very wide FOV, the FOV of the metasurface may be limited to maintain the transmissivity above a threshold transmittance value. For example, to maintain transmission efficiencies above 95% (e.g., a threshold transmittance value of 95%), the FOV of a steerable metasurface may be limited to 120 degrees. Similarly, to maintain transmission efficiencies above 90%, the FOV of a steerable metasurface may be limited to 120 degrees. The specific FOV of the metasurface is based on a function of the physical steering capabilities of the metasurface, the optical properties of the transparent cover or anti-reflective coating, and a target threshold transmittance value.

The presently described systems and methods relate to expanding the FOV of a metasurface while still maintaining transmission efficiencies above a target threshold transmittance value by use of a freeform optic. In some embodiments, a freeform optic is used in combination with a prism. For example, a coupling prism may be used, inter alia, to prevent the obstruction of the output beam with the input incident beam. U.S. Pat. No. 11,567,390, granted on Jan. 31, 2023, entitled “Coupling Prisms for Tunable Optical Metasurfaces,” is hereby incorporated by reference in its entirety. As described herein, the presently described freeform optics and various configurations thereof allow for an expanded FOV of up to 180 degrees or even beyond 180 degrees (e.g., 210 degrees) in the steering direction. The freeform optic may operate to expand the fixed FOV of a metasurface in the non-steering direction from, for example, a fixed FOV of 20 degrees to an expanded fixed FOV of 90 degrees.

Any of a wide variety of tunable optical metasurfaces, advancements, variations, and improvements thereto may be utilized in conjunction with embodiments described herein, including one-dimensionally steerable optical metasurfaces and two-dimensionally steerable optical metasurfaces. In some embodiments, two-dimensional steering is accomplished using a one-dimensionally steerable optical metasurface in conjunction with selective activation of segmented lasers (e.g., VCSELs), as described in the disclosure incorporated by reference herein. Various metasurfaces, configurations, lidar components, transmitter subsystems, receiver subsystems, and the like that are applicable to this disclosure, may be utilized in combination with the embodiments of this disclosure, and/or may be otherwise be useful to understand this disclosure more fully are described in U.S. Pat. No. 10,451,800 granted on Oct. 22, 2019, entitled “Plasmonic Surface-Scattering Elements and Metasurfaces for Optical Beam Steering;” U.S. Pat. No. 10,665,953 granted on May 26, 2020, entitled “Tunable Liquid Crystal Metasurfaces;” U.S. Pat. No. 11,092,675 granted on Aug. 17, 2021, entitled “Lidar Systems based on Tunable Optical Metasurfaces;” U.S. Pat. No. 11,429,008 granted on Aug. 20, 2022, entitled “Liquid Crystal Metasurfaces with Cross-Backplane Optical Reflectors;” U.S. patent Publication No. 2012/0194399, published on Aug. 2, 2012, entitled “Surface Scattering Antennas;” U.S. patent Publication No. 2019/0285798 published on Sep. 19, 2019, entitled “Plasmonic Surface-Scattering Elements and Metasurfaces for Optical Beam Steering;” and U.S. patent Publication No. 2018/0241131 published on Aug. 23, 2018, entitled “Optical Surface-Scattering Elements and Metasurfaces;” each of which is hereby incorporated by reference in its entirety. Additional elements, applications, and features of surface scattering antennas are described in U.S. patent Publication No. 2014/0266946, published Sep. 18, 2014, entitled “Surface Scattering Antenna Improvements;” U.S. patent Publication No. 2015/0318618, published Nov. 5, 2015, entitled “Surface Scattering Antennas with Lumped Elements;” U.S. patent Publication No. 2015/0318620 published Nov. 5, 2015, entitled “Curved Surface Scattering Antennas;” U.S. patent Publication No. 2015/0380828 published on Dec. 31, 2015, entitled “Slotted Surface Scattering Antennas;” U.S. patent Publication No. 2015/0162658 published Jun. 11, 2015, entitled “Surface Scattering Reflector Antenna;” U.S. patent Publication No. 2015/0372389 published Dec. 24, 2015, entitled “Modulation Patterns for Surface Scattering Antennas;” PCT Application No. PCT/US18/19269 filed on Feb. 22, 2018, entitled “Control Circuitry and Fabrication Techniques for Optical Metasurfaces,” U.S. patent Publication No. 2019/0301025 published on Oct. 3, 2019, entitled “Fabrication of Metallic Optical Metasurfaces;” U.S. Publication No. 2018/0248267 published on Aug. 30, 2018, entitled “Optical Beam-Steering Devices and Methods Utilizing Surface Scattering Metasurfaces;” U.S. Pat. No. 11,747,446 issued on Sep. 5, 2023, entitled “Segmented Illumination and Polarization Devices for Tunable Optical Metasurfaces;” and U.S. Pat. No. 11,846,865 issued on Dec. 19, 2023, entitled “Two-Dimensional Metasurface Beam Forming Systems and Methods,” each of which is hereby incorporated by reference in its entirety.

The presently described systems and methods can be understood in the context of the above description and the patents and patent publications cited above. In various examples, an optical system includes a tunable optical metasurface (e.g., a one-dimensionally steerable LCM) that is selectively steerable in a steering direction to a plurality of steering angles. A freeform optic is positioned within an optical path of the metasurface. An air gap may exist between the freeform optic and the metasurface. The freeform optic gradually bends (refracts) the optical rays in terms of angle of incidence (and angle of departure) through the consecutive interfaces to bend (e.g., by refraction diffraction) the optical radiation with minimal losses.

For example, the optical path from the metasurface may include a metasurface cover-to-air interface, an air-to-freeform optic interface, and a freeform optic-to-air interface. In embodiments that include a prism, the optical path from the metasurface may include a metasurface cover-to-prism interface, a prism-to-air interface, an air-to-freeform optic interface, and a freeform optic-to-air interface. In a receiver configuration, a reverse optical path includes the same interfaces in the reverse order with the same cumulative optical properties.

The freeform optic may for example, include a concave first surface positioned proximate to the metasurface and a biconic second surface. In various embodiments, the second surface may have a first radius of curvature along a first axis in the steering direction of the metasurface and a second radius of curvature along a second axis in a non-steering direction of the metasurface, wherein the first radius of curvature along the first axis is different than the second radius of curvature along the second axis. The concave first surface may be rotationally symmetric in some embodiments. In other embodiments, the concave first surface may be a biconic surface, a biconic Zernike surface, an extended polynomial surface, a Zernike polynomial surface, or a Chebyshev polynomial surface.

As described herein, the freeform optic is positioned relative to the metasurface with an air gap between the concave first surface of the freeform optic and the metasurface. In some embodiments, a prism may also be positioned between the freeform optic and the metasurface, in which case an air gap exists between the prism and the freeform optic. The first surface of the freeform optic may for example, have a spherical or conical radius of curvature and/or may be rotationally symmetric. The first and second radii of curvature of the second surface (e.g., the surface opposing the first surface) of the freeform optic may be selected such that the second surface comprises a biconic surface, a biconic Zernike surface, an extended polynomial surface, a Zernike polynomial surface, or a Chebyshev polynomial surface.

In various embodiments, the first and second surfaces of the freeform optic may be shaped to compensate for one or more optical distortions introduced by the metasurface, adjust a steering line width of the metasurface, and/or correct a steering asymmetry of the metasurface. For example, the freeform optic may be configured to adjust for and/or compensate for one or more of the distortions or curvatures described in U.S. Pat. No. 11,092,675 granted on Aug. 17, 2021, entitled “Lidar Systems based on Tunable Optical Metasurfaces,” which is incorporated by reference above.

As described herein, including in conjunction with FIGS. 1-2B, the metasurface may be selectively steerable within a first FOV in the steering direction for which the optical transmissivity is above a threshold transmittance value. The transmissivity may be below an acceptable threshold value at steering angles outside of the first FOV due to Fresnel losses. For example, the first FOV of the metasurface may be limited to between 100 and 140 degrees. The first surface of the freeform optic (e.g., a rotationally symmetric concave first surface, a biconic concave first surface, etc.) and the first radius of curvature along the first axis in the steering direction of the metasurface may operate together to expand the first FOV of the metasurface to an expanded FOV while maintaining an optical transmissivity above the threshold transmittance value. The expanded FOV may allow for steering angles within an expanded FOV that is greater than the first FOV of the metasurface (e.g., 140-210 degrees).

The specific FOV of the metasurface may depend, in part, on an acceptable transmittance efficiency for a particular application. For example, a threshold transmittance value may be used between 80% and 99% that, for a given anti-reflective coating on a cover, a metasurface may limit the useable FOV for direct steering by the metasurface.

In some embodiments, the freeform optic may be embodied as and/or include one or more of a metalens formed on a curved substrate, a diffractive optical element, a refractive optical element, a reflective optical element, diffraction gratings, and/or the like.

The metasurface and freeform optic may be used as part of a transmitter system. The transmitter system may include an optical radiation source, such as a laser or laser array, to generate optical radiation to be reflected and/or refracted by the metasurface for transmission through the freeform optic. In such embodiments, the transmitted optical radiation is steered by the metasurface within the first FOV in the steering direction. For one-dimensionally steerable metasurfaces, the metasurface may reflect and/or refract the transmitted optical radiation with a second, fixed FOV in the non-steering direction (e.g., a fixed FOV of between 10 and 30 degrees).

As described herein, the first radius of curvature of the freeform optic along the first axis in the steering direction may operate (in conjunction with the concave first surface) to expand the first FOV. The second radius of curvature along the second axis in the non-steering direction of a one-dimensionally steerable metasurface may operate (in conjunction with the concave first surface to expand, narrow, or maintain the second, fixed FOV. For example, the second radius of curvature along the second axis in the non-steering direction may expand the native fixed FOV of the metasurface (or native fixed FOV of the metasurface and laser assembly) in the non-steering direction (e.g., 10-30 degrees) to an expanded fixed FOV in the non-steering direction (e.g., 60-120 degrees).

A controller (e.g., a driver) may control the operation of one or more optical radiation sources and/or the steering of the metasurface to scan a region of space with a sequence of scan lines (e.g., scan lines at a contiguous set of steering angles or a set of scan lines at arbitrary or discontiguous steering angles). In some embodiments, the optical radiation source includes a set of vertical-cavity surface-emitting lasers (VCSELs). Subsets of the VCSELs can be activated to attain narrower scan lines and/or to achieve some partial steering in the non-steering direction of the metasurface, as described in the patents and patent applications incorporated herein by reference.

Embodiments of this disclosure may be used for transmitter subsystems or devices, receiver subsystems or devices, and/or transceiver subsystems or devices of three-dimensional sensing systems (e.g., lidar systems). In various embodiments, an optical detector sensor (e.g., photodiodes) may operate to receive optical radiation reflected by the metasurface. For example, the metasurface may reflect optical radiation to the optical detector sensor that is received through the freeform optic at selective steering angles within a first FOV in the steering direction and within a fixed FOV in the non-steering direction.

In some embodiments, a freeform optic may be used in conjunction with a two-dimensionally steerable tunable optical metasurface. The two-dimensionally steerable metasurface may be selectively steerable in a first steering direction to a first plurality of steering angles within the first FOV and selectively steerable in a second steering direction to a second plurality of steering angles within a second FOV. As in other embodiments, the freeform optic may include a concave first surface positioned proximate to the metasurface. The concave first surface may be a spherical or conical rotationally symmetric surface, a biconic surface, a biconic Zernike surface, an extended polynomial surface, a Zernike polynomial surface, or a Chebyshev polynomial surface. The freeform optic also includes a biconic second surface that has a first radius of curvature along a first axis in the first steering direction of the metasurface and a second radius of curvature along a second axis in the second steering direction of the metasurface. The first radius of curvature along the first axis may still be different than the second radius of curvature along the second axis. However, in some embodiments in which the freeform optic is used in conjunction with a two-dimensionally steerable tunable optical metasurface, the biconic second surface of the freeform optic is rotationally symmetric.

Specific examples of freeform optics are described herein for use in conjunction with metasurfaces for transmitter and/or receiver subsystems of lidar or other three-dimensional sensor systems. A lidar transmitter may include a laser assembly (e.g., an array or set of VCSELs) to generate optical radiation. A one-dimensionally steerable tunable optical metasurface operates to selectively steer incident optical radiation in a steering direction for transmission at a plurality of steering angles within a first FOV. The first FOV may correspond to those steering angles for which the optical transmissivity is above a threshold transmittance value. The metasurface may operate to transmit the optical radiation at a fixed FOV in the non-steering direction.

As previously described, partial steering may be accomplished in the non-steering direction by the selective activation of subsets of the VCSELs). For example, a first subset of VCSELs may be activated for a 20-degree FOV from −20 degrees to 0 degrees in the non-steering direction, and a second subset of VCSELs may be activated for a different 20-degree FOV from 0 degrees to +20 degrees in the non-steering direction. In such embodiments, the one-dimensionally steerable metasurface still operates with a fixed FOV in the non-steering direction. In still other embodiments, a two-dimensionally steerable metasurface may be utilized. In embodiments in which partial or full steering is possible in the two different directions, the freeform optic may be configured to provide an expanded FOV in both steering directions while maintaining a higher transmittance value (optical transmission efficiency) than would be possible using the metasurface alone (e.g., due to Fresnel losses at extreme steering angles, as described in detail herein).

An optical assembly, such as one or more prisms, mirrors, lenses, waveguides, light guides, and/or the like, may be utilized to convey the optical radiation generated by the laser assembly to the metasurface. A lidar controller may cause the laser assembly to generate optical radiation and tune the metasurface to steer incident optical radiation as a sequence of transmit scan lines at various steering angles (contiguous or otherwise) within the first FOV. The freeform optic is positioned within the optical path of the metasurface and operates to expand the FOV of the metasurface in at least the steering direction, such that the optical radiation can be steered within an expanded FOV that is larger than the metasurface FOV while still maintaining an optical transmissivity above a target or selected threshold transmittance value.

Similarly, a lidar receiver may include an array of detector elements to detect optical radiation as a received scan line (e.g., a one-dimensional or two-dimensional array of photodiodes, various filters, collimators, microlenses, and/or the like). A tunable optical metasurface is steerable to reflect incident optical radiation to the array of detector elements at each of a plurality of receive steering angles within a first FOV in the steering direction. Again, the FOV of the metasurface may be limited (e.g., between 100 and 140 degrees) to achieve an optical transmissivity above a threshold transmittance value. The metasurface may operate to reflect incident optical radiation to the array of detector elements at each of the plurality of receive steering angles within a second, fixed FOV in the non-steering direction.

The lidar receiver may include a prism and/or other optical elements to convey the optical radiation reflected by the metasurface to the array of detector elements. Again, a controller may tune the metasurface (e.g., by driving a pattern of voltage differentials, as described in the references incorporated herein by reference) to receive optical radiation at a sequence of receive steering angles within the first FOV. The freeform optic is positioned within the optical path of the metasurface with an air gap between the freeform optic and the prism. The freeform optic has first and second surfaces that are configured to expand the first FOV in the steering direction to an expanded FOV while maintaining the optical transmissivity above the threshold transmittance value.

Similar to the other embodiments described herein, the freeform optic may be embodied as and/or include a metalens formed on a curved substrate, a diffractive optical element, a refractive optical element, a reflective optical element, a diffraction grating, a Fresnel lens, anti-reflective coatings, multiple layers, multiple elements, and/or the like. In various examples, the freeform optic includes a concave first surface positioned proximate to the metasurface (e.g., closest to the metasurface) and a biconic second surface that is farther from the metasurface. The concave first surface may be a spherical rotationally symmetric surface, a conical rotationally symmetric surface, a biconic surface, a biconic Zernike surface, an extended polynomial surface, a Zernike polynomial surface, or a Chebyshev polynomial surface. The second surface may have a first radius of curvature along a first axis in the steering direction of the metasurface and a second radius of curvature along a second axis in a non-steering direction of the metasurface.

Some of the infrastructure that can be used with embodiments disclosed herein is already available, such as general-purpose computers, computer programming tools and techniques, digital storage media, and communication links. Many of the systems, subsystems, modules, components, and the like that are described herein may be implemented as hardware, firmware, and/or software. Various systems, subsystems, modules, and components are described in terms of the function(s) they perform because such a wide variety of possible implementations exist.

It is also appreciated that two or more of the elements, devices, systems, subsystems, components, modules, etc. that are described herein may be combined as a single element, device, system, subsystem, module, or component. Moreover, many of the elements, devices, systems, subsystems, components, and modules may be duplicated or further divided into discrete elements, devices, systems, subsystems, components, or modules to perform subtasks of those described herein. Any aspect of any embodiment described herein may be combined with any other aspect of any other embodiment described herein and/or with the various embodiments described in the disclosures incorporated by reference, including all permutations and combinations thereof, consistent with the understanding of one of skill in the art reading this disclosure in the context of such other disclosures.

To the extent used herein, a computing device, system, subsystem, module, driver, or controller may include a processor, such as a microprocessor, a microcontroller, logic circuitry, or the like. The components of some of the disclosed embodiments are described and illustrated in the figures herein to provide specific examples. Many portions thereof could be arranged and designed in a wide variety of different configurations. In many instances, well-known structures, materials, or operations are not shown or described in detail to avoid obscuring aspects of this disclosure.

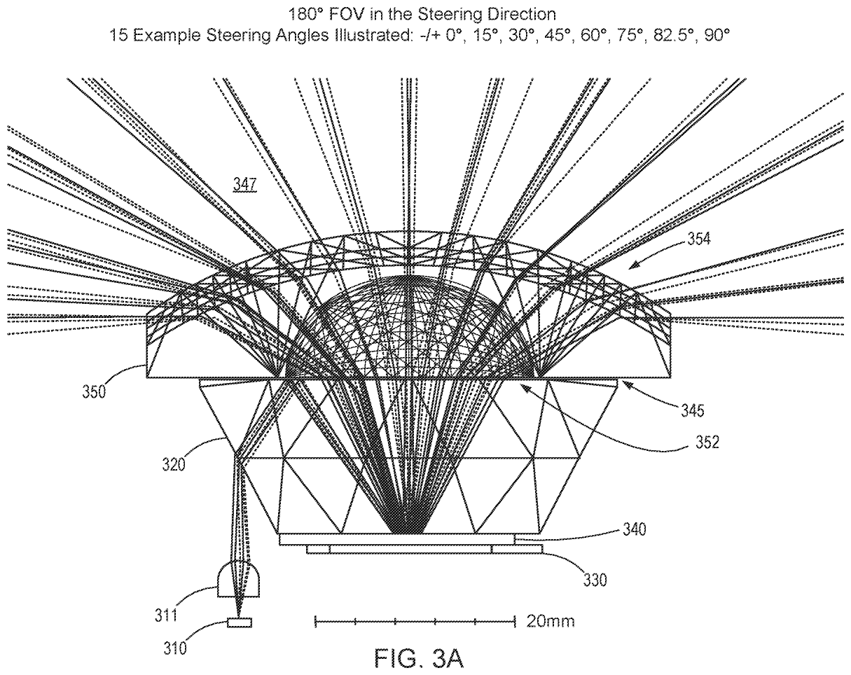

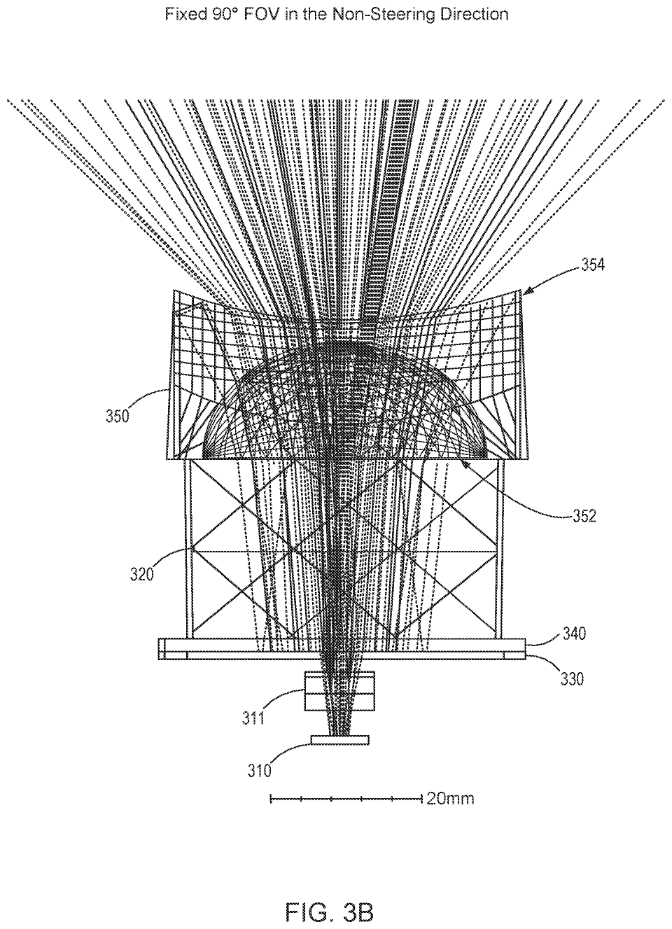

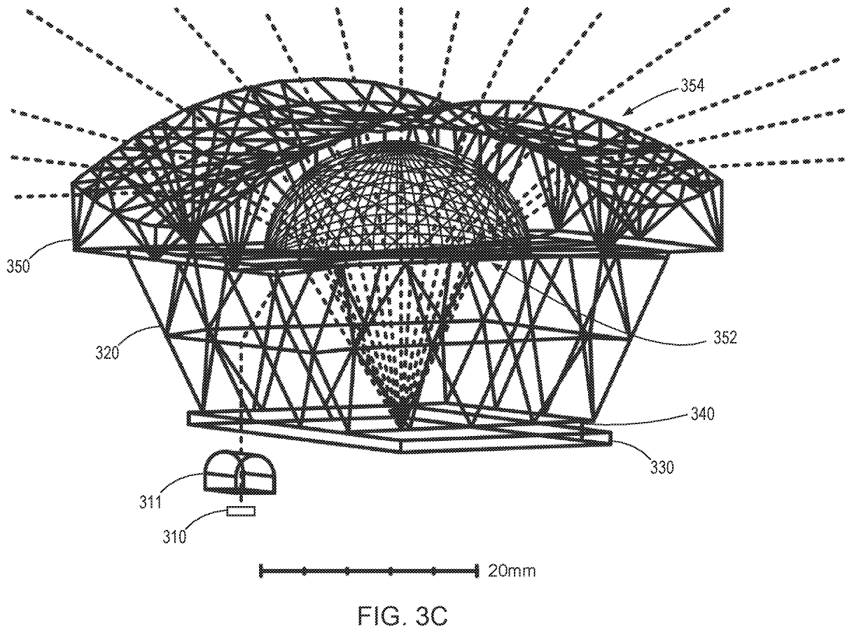

FIG. 3A illustrates a block diagram from a side view in the steering direction of a metasurface 330 with a prism 320 and a freeform optic 350, according to one embodiment. In the illustrated example, the metasurface 330 is selectively steerable in a steering direction to a plurality of steering angles. As described herein, the metasurface may be constrained to steering within a first FOV (a metasurface FOV) for which the transmissivity is above a threshold transmittance value. In the illustrated example, the metasurface FOV is 120 degrees, with the metasurface steering from approximately −60 degrees to approximately +60 degrees.

Optical radiation from a laser assembly 310 is directed through a lens assembly 311 into the prism 320. The prism 320 allows the optical radiation to be directed from the laser assembly 310 for incidence on and steering by the metasurface 330 without obstructing the FOV of the metasurface. A transparent cover 340 (e.g., glass) on the metasurface 330 may have an anti-reflective coating to improve transmittance at various steering angles. However, as illustrated in FIG. 2B, even with an anti-reflective coating, the transmittance may decrease at higher angles (e.g., at angles greater than 60 degrees). Accordingly, the metasurface 330 may be limited to steering to angles within the first FOV of 120 degrees to maintain the transmissivity above a target transmittance value.

The freeform optic 350 is positioned above the prism 320 with a small air gap 345 therebetween. The airgap 345 is not visible in all the figures but may be present in any of the various embodiments to create an additional optical transition for bending the optical radiation gradually. The freeform optic 350 includes a first surface 352 (a lower surface as depicted) that is proximate to the metasurface 330 and a second surface 354 (an upper surface as depicted) that is opposite the first surface 352 and farther from the metasurface 330.

The first surface 352 includes surrounding planar sections outside the optical path that may be sized to support the freeform optic 350 and/or used for convenience in mounting. However, the portion of the first surface 352 that is within the optical path of the metasurface 330 is concave. In some embodiments, the concave first surface may be a biconic surface, a biconic Zernike surface, an extended polynomial surface, a Zernike polynomial surface, or a Chebyshev polynomial surface. In the illustrated example, the first surface 352 is rotationally symmetric and concave with a spherical radius of curvature or a conical radius of curvature. The biconic second surface 354 has a first radius of curvature along a first axis in the steering direction of the metasurface 330 and a second radius of curvature along a second axis in a non-steering direction of the metasurface 330. From the illustrated perspective, the first radius of curvature along the first axis in the steering direction is visible as a convex radius of curvature relative to the metasurface 330.

The freeform optic 350 expands the metasurface FOV of 120 degrees out of the prism 320 to an expanded FOV of 200 degrees. The freeform optic 350 allows the angle of incidence and the angle of departure of optical radiation at the interface of the metasurface 330 and the transparent cover 340 to be less than 60 degrees at all steering angles between −100 degrees and +100 degrees in the steering direction of the metasurface 330. The reflectance or Fresnel losses may be maintained at less than 1% while still allowing for a large effective FOV of at least 180 degrees. The freeform optic slowly (e.g., gradually) bends the optical rays in terms of angle of incidence (and angle of departure) through a sequence of three optical interfaces. The first interface is between the prism 320 and the air gap 345. The second interface is between the airgap 345 and the first surface 352 of the freeform optic 350. The third interface is between the second surface 354 of the freeform optic 350 and the air 347 outside of the device.

Accordingly, the freeform optic 350 includes a concave first surface 352 and a biconic second surface 354. A biconic surface is a surface that has a different radius of curvature along its two orthogonal axes. Each surface can be defined as various types of forms that have different design advantages based on symmetry, shape (e.g., round versus rectangular), and/or optical design optimization (computational convergence or speed). For instance, one or both of the first and second surfaces may be a biconic surface, a biconic Zernike surface, an extended polynomial surface, a Zernike polynomial surface, and a Cherbyshev polynomial surface. Complex biconic surfaces having two different spherical or conical radii of curvatures with different conic constants may be used to correct other asymmetries in the system, correct distortion, control an angle of incidence or an angle of departure on a surface, adjust line beam straightness, adjust a line beam pin cushion, adjust for barrel distortion, correct for conical diffraction of the metasurface, or the like.

FIG. 3B illustrates a block diagram from a side view in the non-steering direction of the metasurface 330, prism 320, and freeform optic 350, according to one embodiment. As illustrated, the second surface, 354, of the freeform optic 350 has a second radius of curvature along the second axis in the non-steering direction of the metasurface 330, which is concave relative to the metasurface 330. As such, the second surface 354 is saddle-shaped in that it is convex in one direction (in the steering direction) and concave in the other direction (in the non-steering direction). The second radius of curvature along the second axis in the non-steering direction operates to expand the native divergence of the laser assembly 310.

For example, the laser assembly 310 may have a native divergence of approximately 20 degrees. The second radius of curvature of the second surface 354 (in conjunction with the concave first surface 352) operates to expand the native divergence such that the transmitted optical radiation has an expanded divergence or fixed FOV in the non-steering direction. In the illustrated example, the 20-degree native divergence of the laser assembly 310 is expanded to a fixed 90-degree FOV. The laser assembly 310 may include VCSELs, edge-emitting lasers, and/or another source, each of which may have unique or different divergence characteristics that can be expanded to a desired target FOV based on the second radius of curvature of the second surface 354. In some embodiments, the native intensity or power distribution profiles of the laser assembly 310 may be modified to be more even, more focused toward the center, and/or more focused toward one or both edges of the fixed FOV or divergence in the non-steering direction.

FIG. 3C illustrates a block diagram of a perspective view of the metasurface 330, prism 320, and freeform optic 350, according to one embodiment. The illustrated view facilitates a more complete understanding of the concave first surface 352 and the saddle-shaped second surface 354 of the freeform optic 350. As previously described, the optical radiation from the laser assembly 310 is conveyed by an optical assembly that includes lens(es) 311 and prism 320 for incidence on the metasurface 330. The optical radiation is steered in a steering direction within a relatively narrow FOV (e.g., 100-140 degrees) to ensure low Fresnel losses (e.g., less than 1-5%) at the interface of the anti-reflective coated transparent cover 340. The relatively narrow metasurface FOV is expanded to an expanded FOV by the freeform optic 350. The expanded FOV may be, for example, 170 degrees, 180 degrees, or more. In the non-steering direction, the freeform optic 350 operates to expand the divergence of the transmitted optical radiation from a native divergence of 10-30 degrees to an expanded fixed FOV in the non-steering direction of between, for example, 60 degrees and 120 degrees.

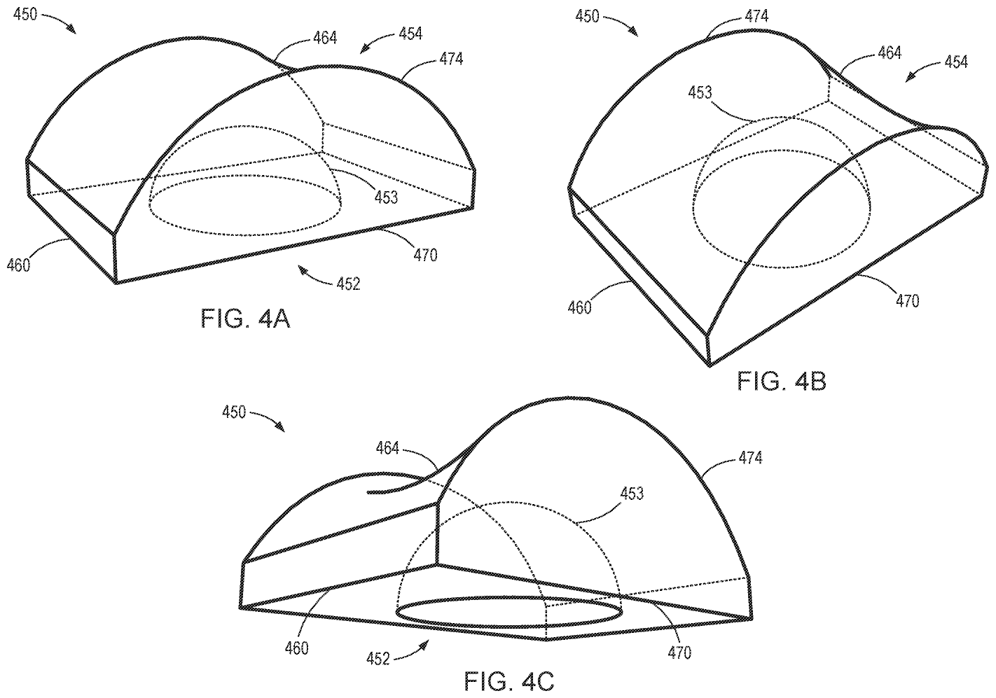

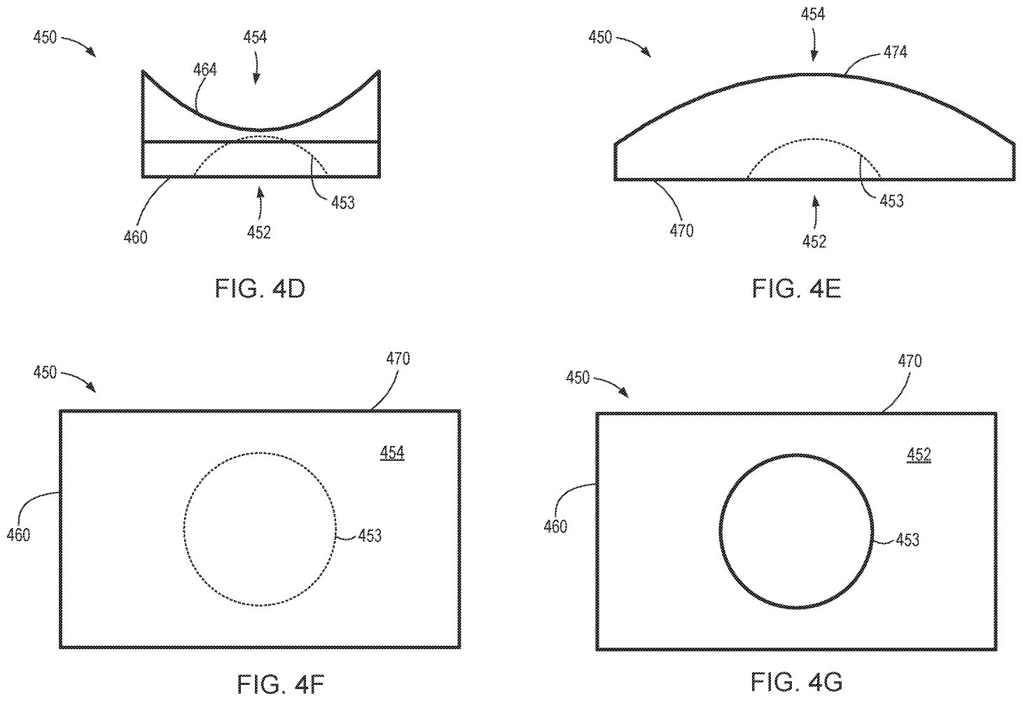

FIGS. 4A-4G illustrate block diagrams from various perspectives of an example freeform optic 450, according to various embodiments. The following description is provided with respect to FIGS. 4A-4G collectively to facilitate a further understanding of the example embodiment of the freeform optic 450.

In the various illustrations, a steering direction is defined in the direction of the long edge 470, and a non-steering direction is defined in the direction of the short edge 460. The lower or first surface 452 is concave and may have a rotationally symmetric spherical or conical radius of curvature 453. Alternatively, the first surface 452 may be a concave biconic surface, a concave biconic Zernike surface, a concave extended polynomial surface, a concave Zernike polynomial surface, or a concave Chebyshev polynomial surface. The first surface 452 is positioned within an optical path of a metasurface with an airgap between the metasurface and the lower or first surface 452 (or between a prism and the lower or first surface 452 in embodiments that employ a prism between the metasurface and the freeform optic 450).

The upper surface 454, which is opposite the first surface 452, has a first radius of curvature 474 along the first axis in the steering direction (along the long edge 470) that is convex. The convex shape of the upper surface 454, as defined by the first radius of curvature 474, is emphasized in FIG. 4E. The upper surface 454 has a second radius of curvature 464 along the second axis in the non-steering direction (along the short edge 460) that is concave. The concave shape of the upper surface 454, as defined by the second radius of curvature 464, is emphasized in FIG. 4D. The saddle-shaped upper surface 454 is visible in FIGS. 4A-4C.

The illustrated embodiments show the freeform optic 450 as being rectangular with a short edge 460 and a long edge 470. However, it is appreciated that in some embodiments, the freeform optic 450 may be square, circular, and/or have another polygonal, irregular, or freeform base shape.

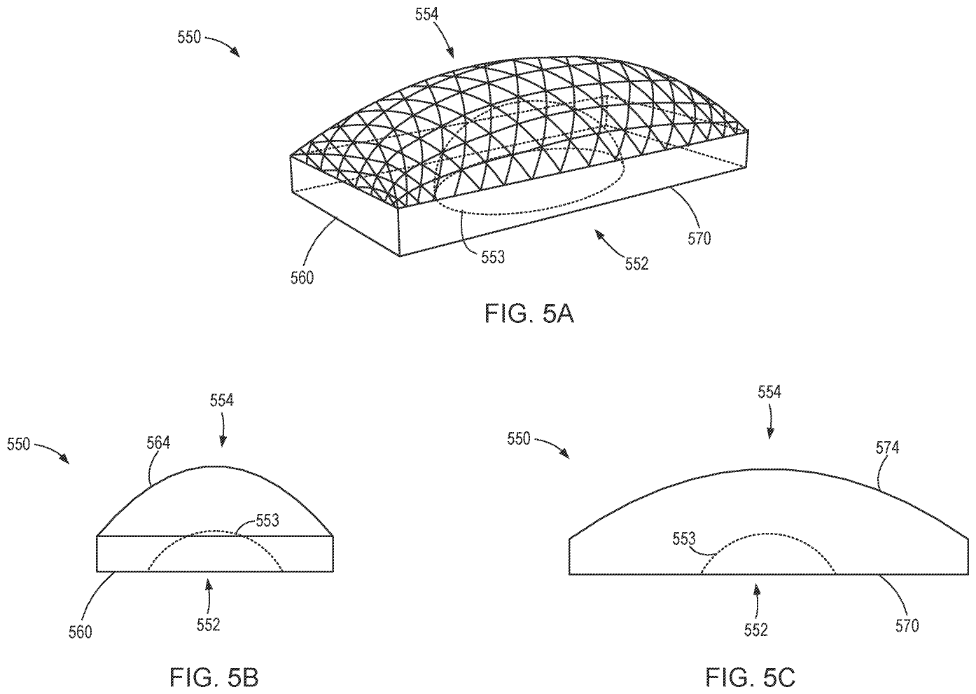

FIG. 5A illustrates a block diagram of a perspective view of an example freeform optic 550 for a two-dimensionally steerable metasurface, according to one embodiment. A first steering direction is defined along the short edge 560, and a second steering direction is defined along the long edge 570. A first, lower surface 552 of the freeform optic 550 includes a concave, rotationally symmetric spherical or conical radius of curvature 553. The upper surface 554 of the freeform optic 550 may also be rotationally symmetric in some embodiments. In other embodiments, the upper surface 554 of the freeform optic 550 is convex in both steering directions but has different radii of curvature in each steering direction.

FIG. 5B illustrates a block diagram from a side view in a first steering direction of the example freeform optic 550 for the two-dimensionally steerable metasurface, according to one embodiment. As illustrated, the lower surface 552 of the freeform optic 550 includes a concave, rotationally symmetric spherical or conical radius of curvature 553. The upper surface 554 of the freeform optic 550 has a convex radius of curvature 564 in the first steering direction along the short edge 560 of the freeform optic 550.

FIG. 5C illustrates a block diagram from a side view in a second steering direction of the example freeform optic 550 for the two-dimensionally steerable metasurface, according to one embodiment. Again, the lower surface 552 of the freeform optic 550 is illustrated with a concave, rotationally symmetric spherical or conical radius of curvature 553. The upper surface 554 of the freeform optic 550 has a convex radius of curvature 574 in the second steering direction along the long edge 570 of the freeform optic 550. In the illustrated example, the first radius of curvature 564 in the first steering direction is shorter than the second radius of curvature 574 in the second steering direction. As previously described, in some embodiments, the first and second radii of curvature 564 and 574 of the upper surface 554 are the same, such that the upper surface 554 is a rotationally symmetric convex surface.

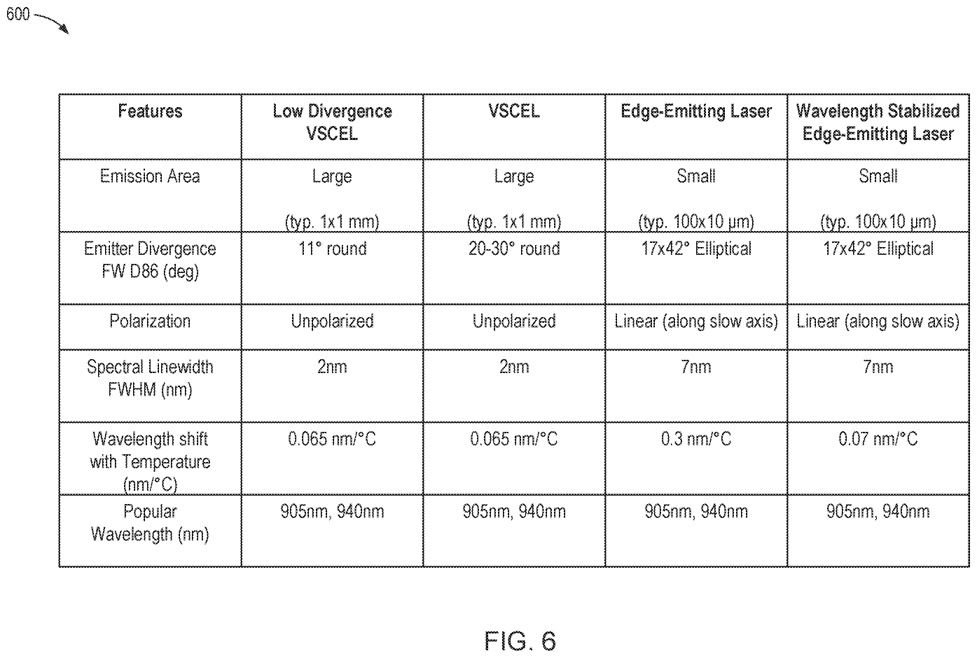

FIG. 6 illustrates a table 600 of features and characteristics of various VCSELs and various edge emitter lasers, according to one embodiment. As described herein, a freeform optic may increase the FOV of a metasurface in the steering direction and increase the native FOV of the light source divergence in the non-steering direction (e.g., in a direction orthogonal to the steering direction). As illustrated, the native divergence of each light source ranges from 11 degrees to approximately 42 degrees (along the long radius of an ellipse). As described herein, the freeform optic may operate to expand the FOV of transmitted optical radiation in the non-steering direction and/or expand the FOV of detected optical radiation in the non-steering direction to a fixed FOV of, for example, 90 degrees. In some embodiments, the freeform optic may be configured to correct the elliptical divergence pattern of edge emitter lasers to ensure uniform or Gaussian distributions.

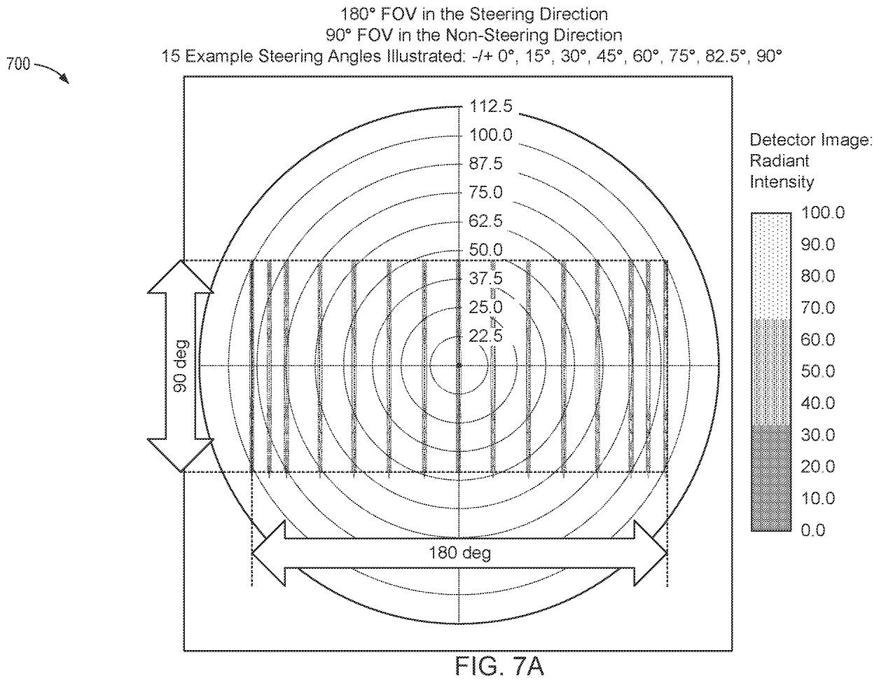

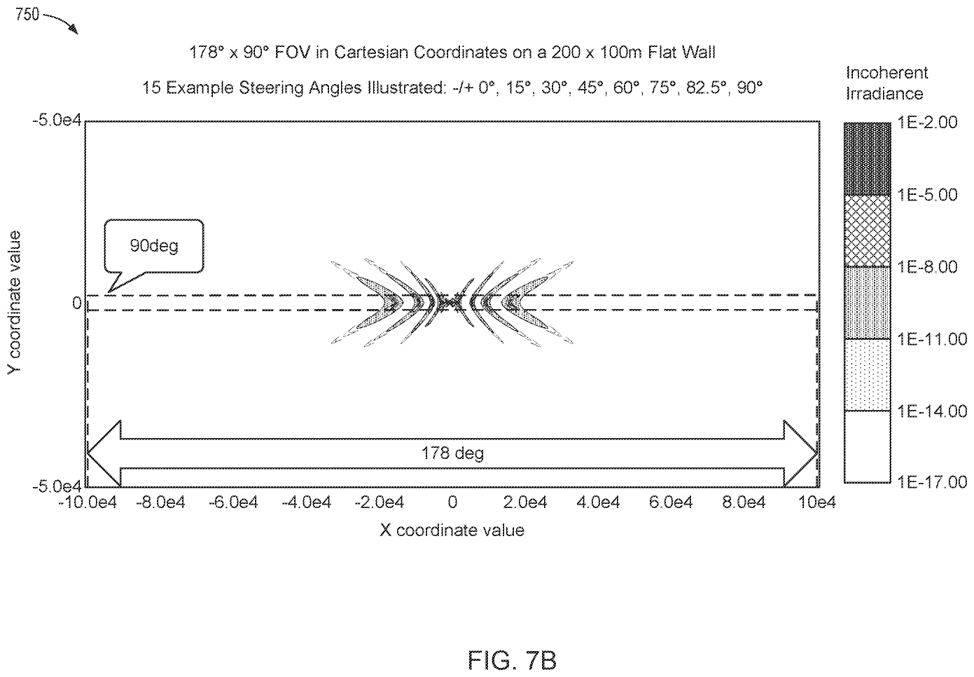

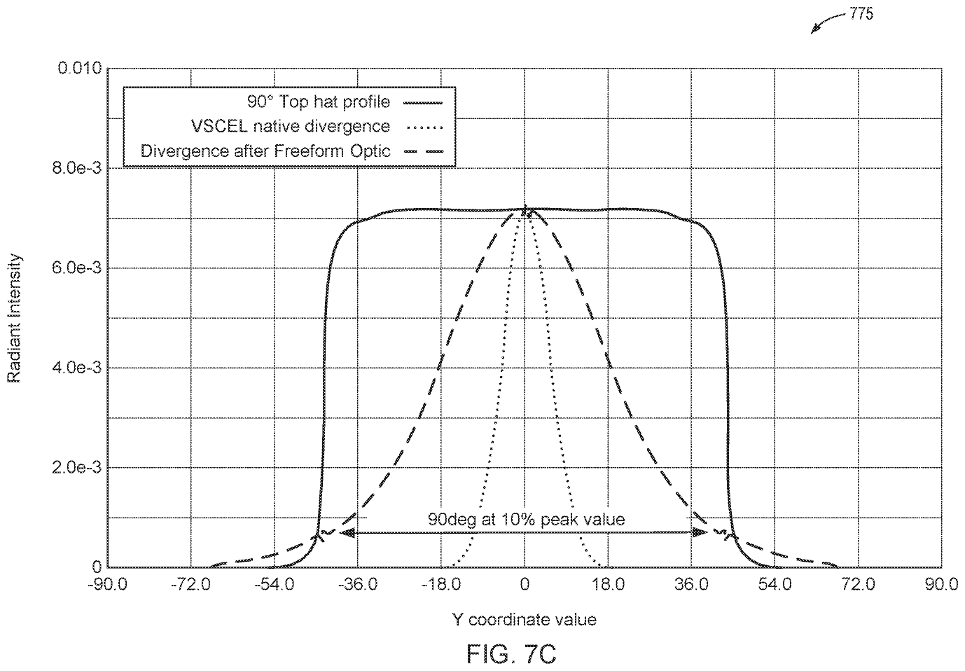

FIG. 7A illustrates example line beams 700 of a metasurface with a freeform optic in a spherical coordinate system, according to one embodiment. As illustrated, the freeform optic provides an FOV that spans 180 degrees in the steering direction with a 90-degree line height or vertical FOV in the non-steering direction. The illustrated example includes fifteen example steering angles at 0 degrees and positive and negative 15 degrees, 30 degrees, 45 degrees, 60 degrees, 75 degrees, 82.5 degrees, and 90 degrees.

FIG. 7B illustrates the line beams 750 in a cartesian coordinate system projected on a wall, according to one embodiment. In the illustrated example, the line beams 750 are projected on a 200-meter by 100-meter wall that is two meters away from the metasurface. As illustrated, the line beams 750 are highly curved outside of the relevant 90-degree divergence in the non-steering direction, which can be ignored.

FIG. 7C illustrates cross-sections 775 of the line beams in the non-steering direction, according to one embodiment. As illustrated, the native divergence of the VSCEL laser assembly is relatively narrow, with most of the power being within less than a 30-degree FOV. The freeform optic increases the divergence to provide for a usable FOV in the non-steering direction of approximately 90 degrees. A target divergence or FOV in the non-steering direction may be adjusted or selected based on a particular application. FOV or divergence ranges between approximately 30 degrees and 120 degrees, or more, are possible.

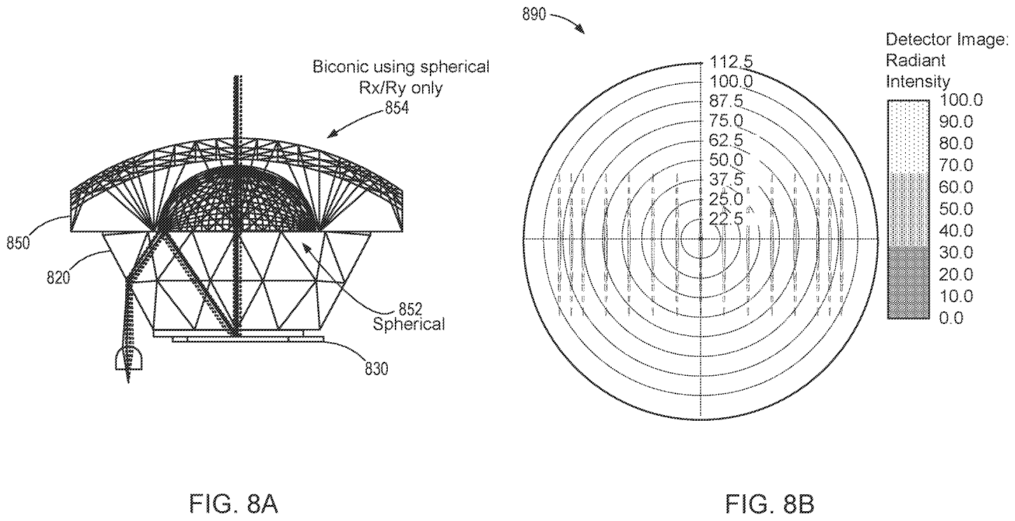

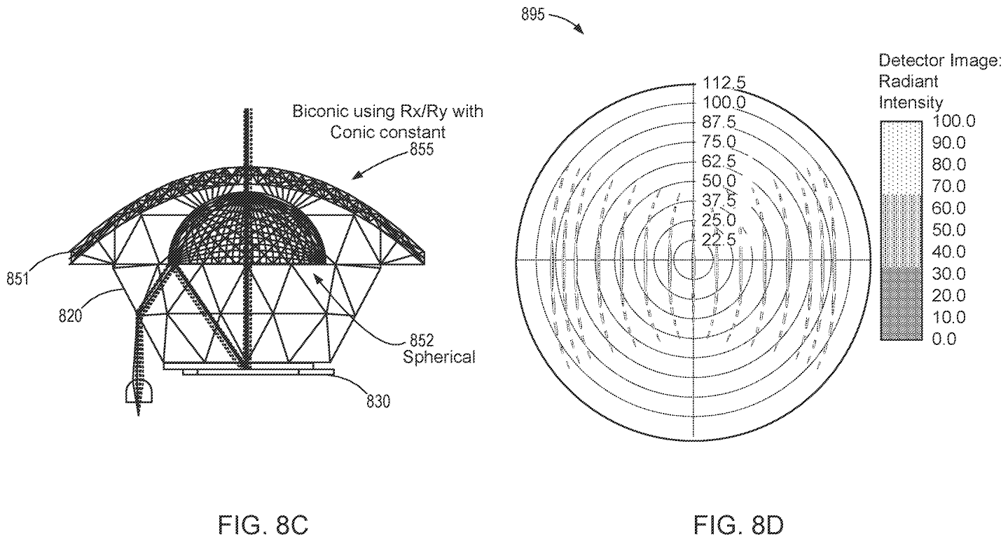

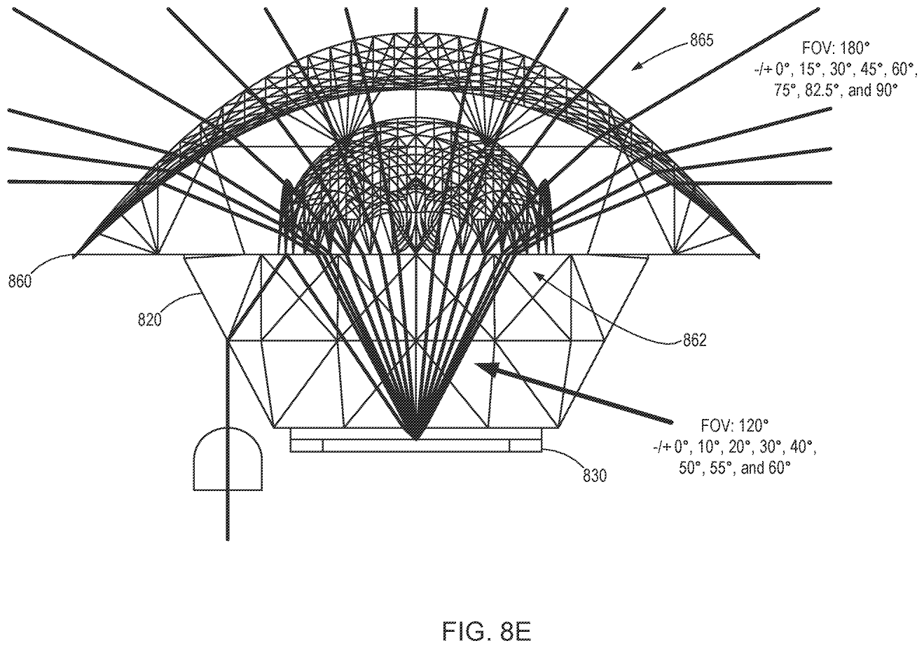

FIG. 8A illustrates an optical layout view of a biconic freeform optic 850 with spherical radii of curvature, according to one embodiment. A prism 820 is positioned between the metasurface 830 and the biconic freeform optic 850. A lower surface 852, which is positioned within the optical path of the metasurface 830, has a concave rotationally symmetric spherical radius of curvature. The upper surface 854 of the biconic freeform optic 850 that opposes the lower surface 852 is also positioned within the optical path of the metasurface 830. The upper surface 854 is biconic with two different spherical radii of curvature. A first spherical radius of curvature is used in a first direction corresponding to the steering direction of the metasurface 830, and a second spherical radius of curvature is used in a second direction corresponding to the non-steering direction of the metasurface 830.

FIG. 8B illustrates line beams 890 of the metasurface and freeform optic with the spherical radii of curvature of FIG. 8A, according to one embodiment. Notably, the line beams 890 are graphed using spherical coordinates, so the relatively straight line beams in the graph would be curved if projected on a two-dimensional surface or graphed in a cartesian coordinate system.

FIG. 8C illustrates an optical layout view of a biconic freeform optic 851 with radii of curvature with different conic constants, according to various embodiments. Again, a prism 820 is positioned between the metasurface 830 and the biconic freeform optic 851. A lower surface 852 of the biconic freeform optic 851 that is closest to the metasurface 830 has a concave rotationally symmetric spherical radius of curvature. The upper surface 855 of the biconic freeform optic 851 that opposes the lower surface 852 is also positioned within the optical path of the metasurface 830. The upper surface 855 is biconic with two different spherical radii of curvature with different conic constants.

A first spherical radius of curvature with a first conic constant is used in a first direction corresponding to the steering direction of the metasurface 830, and a second spherical radius of curvature with a second conic constant is used in a second direction corresponding to the non-steering direction of the metasurface 830. In various embodiments, the far field beam quality is improved by using a more complex freeform optic. The biconic upper surface 855 with higher order terms (spherical radii of curvature with different conic constants) exhibits sharper line beams for the higher steering angles than the spherical-only biconic upper surface 854 of the biconic freeform optic 850 in FIG. 8A.

FIG. 8D illustrates line beams 895 of the metasurface and freeform optic with the radii of curvature with different conic constants of FIG. 8C, according to one embodiment. In contrast to the line beams 890 of FIG. 8B, the line beams 895 conform closely to the graphed angles, such that the line beams would be approximately straight (or at least sharper than those in FIG. 8B) if projected on a two-dimensional surface or graphed in a cartesian coordinate system. This is especially true for the higher steering angles.

FIG. 8E illustrates an optical layout view of a biconic freeform optic 860 with an extended polynomial surface, according to one embodiment. A prism 820 is positioned between the metasurface 830 and the biconic freeform optic 860. A lower surface 862 of the biconic freeform optic 860 that is closest to the metasurface 830 has a concave curvature. For example, the lower surface 862 may have a rotationally symmetric spherical radius of curvature, a rotationally symmetric conical radius of curvature, a concave biconic surface, a concave biconic Zernike surface, a concave extended polynomial surface, a concave Zernike polynomial surface, or a concave Chebyshev polynomial surface.

The upper surface 855 of the biconic freeform optic 860 that opposes the lower surface 862 is also positioned within the optical path of the metasurface 830. The upper surface 865 forms an extended polynomial surface. The extended polynomial upper surface 865 has a first radius of curvature in a first direction corresponding to the steering direction of the metasurface 830. The extended polynomial upper surface 865 has a radius of curvature in a second direction corresponding to the non-steering direction of the metasurface 830. In various embodiments, the far field beam quality is improved through the use of the extended polynomial freeform optic.

The metasurface 830 steers optical radiation within a 120-degree FOV (e.g., steering between −60 degrees and +60 degrees). The upper surface 865 expands the FOV to 180 degrees (or more) to allow for beam steering in the steering direction between −90 degrees and +90 degrees. In the illustrated example, the metasurface 830 is illustrated as steering to angles −/+0°, 10°, 20°, 30°, 40°, 50°, 55°, and 60°, which are mapped by the biconic freeform optic 860 having an upper surface 865 that is an expended polynomial surface to angles −/+0°, 15°, 30°, 45°, 60°, 75°, 82.5°, and 90°. As previously described, the FOV or divergence of optical radiation in the non-steering direction may for example, be expanded from a native divergence (e.g., 20 degrees) to a target divergence (e.g., 90 degrees).

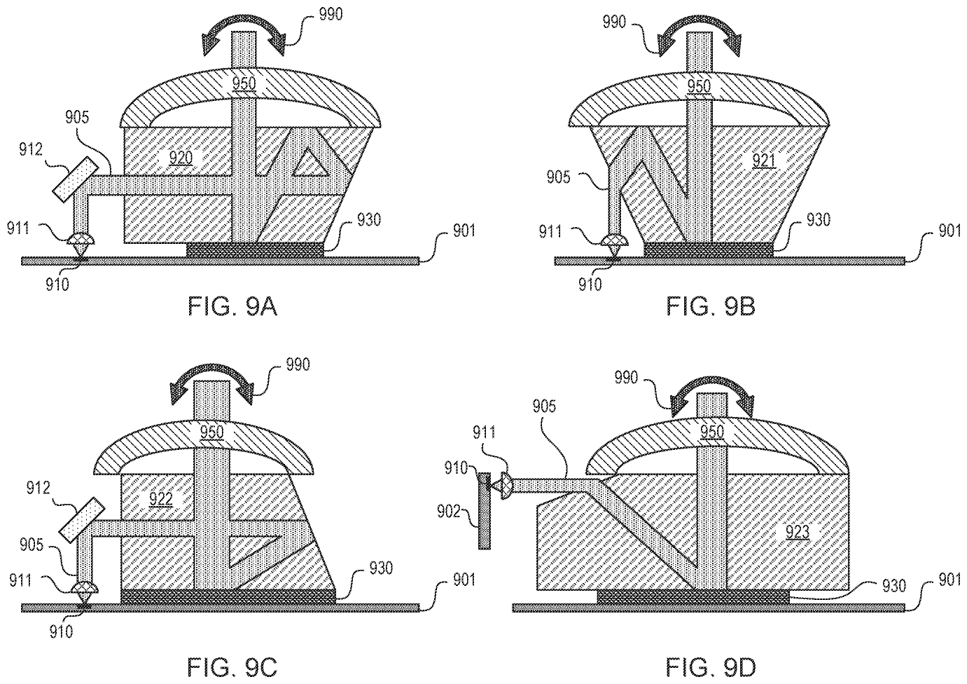

FIG. 9A illustrates an example optical layout of a metasurface 930 on a substrate 901 with a coupling prism 920 and a biconic freeform optic 950, according to one embodiment. As illustrated, optical radiation 905 from a laser assembly 910 passes through an optical assembly that includes lens(es) 911 and mirror(s) 912 before orthogonally entering a vertical face of the coupling prism 920. The coupling prism 920 internally reflects the optical radiation 905 for incidence on the metasurface 930 at a target angle of incidence. The metasurface 930 steers the incident optical radiation 905 in a steering direction 990 within a metasurface FOV (a first FOV) based on the maximum steering angles for which the transmissivity is within a threshold transmittance value (e.g., 90%, 95%, or 99%). The metasurface FOV may be, for example, limited to a 120-degree FOV to reduce or limit Fresnel losses at higher steering angles.

The optical radiation 905 is steered through the coupling prism 920, where it is refracted at the interface between the coupling prism 920 and the air gap. The optical radiation 905 is then refracted again as it enters the first surface of the freeform optic 950 (e.g., a rotationally symmetric spherical concave surface). The optical radiation 905 is refracted again as it departs the second surface of the freeform optic 950 into the air for free space transmission. The second surface of the freeform optic 950 may be biconic, as described herein. The freeform optic 950 expands the FOV in the steering direction 990 to an expanded FOV. As an example, the expanded FOV provided by the freeform optic 950 is approximately 160 degrees in some embodiments, approximately 170 degrees in some embodiments, approximately 180 degrees in some embodiments, and exceeds 180 degrees in some embodiments.

FIG. 9B illustrates another example optical layout of a metasurface 930 on a substrate 901 with a coupling prism 921 and a biconic freeform optic 950, according to one embodiment. As illustrated, optical radiation 905 from a laser assembly 910 passes through an optical assembly that includes lens(es) 911 before entering an angled face of the coupling prism 921. The coupling prism 921 internally reflects the optical radiation 905 for incidence on the metasurface 930 at a target angle of incidence. The metasurface 930 steers the incident optical radiation 905 in a steering direction 990 within a metasurface FOV (a first FOV) based on the maximum steering angles for which the transmissivity is within a threshold transmittance value (e.g., 90%, 95%, or 99%). The metasurface FOV may be, for example, limited to a 120-degree FOV to reduce or limit Fresnel losses at higher steering angles.

The optical radiation 905 is steered through the coupling prism 921, where it is refracted at the interface between the coupling prism 921 and the air gap. The optical radiation 905 is then refracted again as it enters the first surface of the freeform optic 950 (e.g., a rotationally symmetric spherical concave surface). The optical radiation 905 is refracted again as it departs the second surface of the freeform optic 950 into the air for free space transmission. The second surface of the freeform optic 950 may be biconic, as described herein. The freeform optic 950 expands the FOV in the steering direction 990 to an expanded FOV that is between 160 and 210 degrees, according to various embodiments.

FIG. 9C illustrates another example optical layout of a metasurface 930 on a substrate 901 with a coupling prism 922 and a biconic freeform optic 950, according to one embodiment. Again, optical radiation 905 from a laser assembly 910 passes through an optical assembly that includes lens(es) 911 and/or mirror(s) 912 before orthogonally entering a vertical face of the coupling prism 922. The coupling prism 922 internally reflects the optical radiation 905 for incidence on the metasurface 930 at a target angle of incidence. The metasurface 930 steers the incident optical radiation 905 in a steering direction 990 within a metasurface FOV (a first FOV) based on the maximum steering angles for which the transmissivity is within a threshold transmittance value (e.g., 90%, 95%, or 99%). The metasurface FOV may be, for example, limited to a 120-degree FOV to reduce or limit Fresnel losses at higher steering angles.

The optical radiation 905 is steered through the coupling prism 922, where it is refracted at the interface between the coupling prism 922 and the air gap. The optical radiation 905 is then refracted again as it enters the first surface of the freeform optic 950 (e.g., a rotationally symmetric spherical concave surface). The optical radiation 905 is refracted again as it departs the second surface of the freeform optic 950 into the air for free space transmission. The second surface of the freeform optic 950 may be biconic, as described herein. The freeform optic 950 expands the FOV in the steering direction 990 to an expanded FOV that is between 160 and 210 degrees, according to various embodiments.

FIG. 9D illustrates another example optical layout of a metasurface 930 on a substrate 901 with a coupling prism 923 and a freeform optic 950, according to one embodiment. The laser assembly 910 is mounted laterally on a separate substrate 902 to transmit optical radiation 905 through an optical assembly that includes lens(es) 911 into an angled face of the coupling prism 923. The coupling prism 923 refracts the optical radiation 905 for incidence on the metasurface 930 at a target angle of incidence. The metasurface 930 steers the incident optical radiation 905 in a steering direction 990 within a metasurface FOV (a first FOV) based on the maximum steering angles for which the transmissivity is within a threshold transmittance value (e.g., 90%, 95%, or 99%). The metasurface FOV may be, for example, limited to a 140-degree FOV to reduce or limit Fresnel losses at higher steering angles.

The optical radiation 905 is steered through the coupling prism 923, where it is refracted at the interface between the coupling prism 923 and the air gap. The optical radiation 905 is then refracted again as it enters the first surface of the freeform optic 950 (e.g., a rotationally symmetric spherical concave surface). The optical radiation 905 is refracted again as it departs the second surface of the freeform optic 950 into the air for free space transmission. The second surface of the freeform optic 950 may be biconic, as described herein. The freeform optic 950 expands the FOV in the steering direction 990 to an expanded FOV that is between 160 and 210 degrees, according to various embodiments.

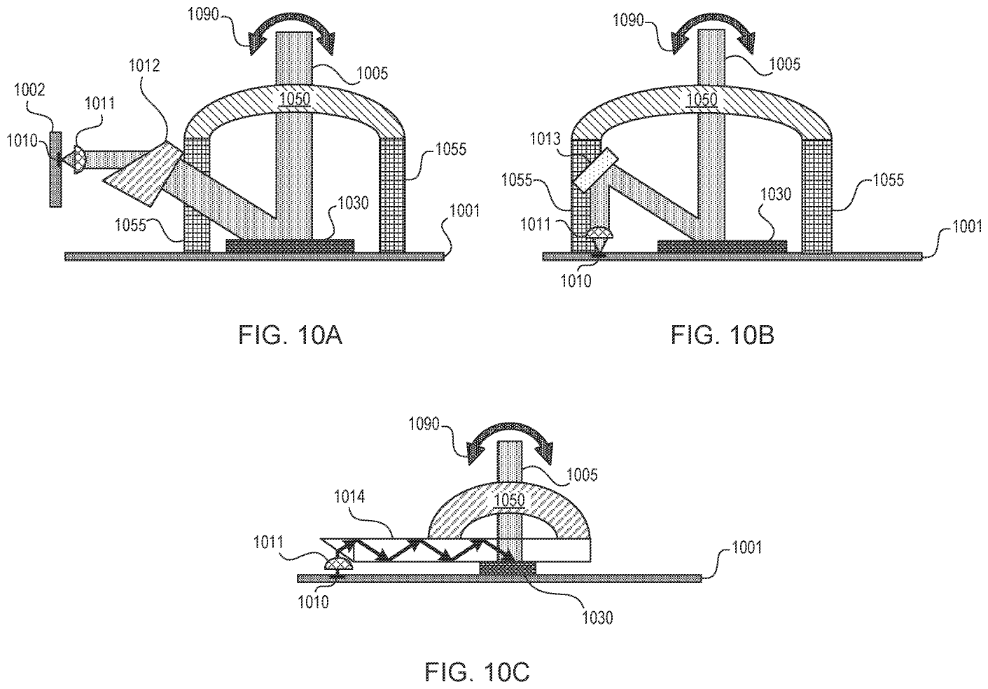

FIG. 10A illustrates an example optical layout of a metasurface 1030 on a substrate 1001 with a biconic freeform optic 1050 separated by free space (air), according to one embodiment. The freeform optic 1050 is suspended above the metasurface 1030 within the optical path of the metasurface by supports 1055. The laser assembly 1010 is mounted laterally on a separate substrate 1002 to transmit optical radiation 1005 through an optical assembly that includes lens(es) 1011 and 1012. The lens 1012 refracts the optical radiation 1005 for incidence on the metasurface 1030 at a target angle of incidence. The metasurface 1030 steers the incident optical radiation 1005 in a steering direction 1090 within a metasurface FOV (a first FOV) based on the maximum steering angles for which the transmissivity is within a threshold transmittance value (e.g., 90%, 95%, or 99%). The metasurface FOV may be, for example, limited to a FOV between 100 and 150 degrees to reduce or limit Fresnel losses at higher steering angles.

The optical radiation 1005 is refracted at the interface between a transparent cover of the metasurface 1030 and the free space air between the freeform optic 1050 and the metasurface 1030. The optical radiation 1005 is then refracted at the interface of the air and the first surface of the freeform optic 1050 (e.g., a rotationally symmetric spherical concave surface or another concave surface). The optical radiation 1005 is refracted again as it departs the second surface of the freeform optic 1050 into the air for free space transmission. The second surface of the freeform optic 1050 may be biconic, as described herein. The freeform optic 1050 expands the FOV in the steering direction 1090 to an expanded FOV that is between 160 and 210 degrees, according to various embodiments.

FIG. 10B illustrates another example optical layout of a metasurface 1030 on a substrate 1001 and a biconic freeform optic 1050 separated by free space, according to one embodiment. The freeform optic 1050 is suspended above the metasurface 1030 within the optical path of the metasurface by supports 1055. The laser assembly 1010 transmits optical radiation 1005 through an optical assembly that includes lens(es) 1011 for reflection by a mirror 1013 on the metasurface 1030 at a target angle of incidence. The metasurface 1030 steers the incident optical radiation 1005 in a steering direction 1090 within a metasurface FOV (a first FOV) based on the maximum steering angles for which the transmissivity is within a threshold transmittance value (e.g., 90%, 95%, or 99%).

The optical radiation 1005 is refracted at the interface between a transparent cover of the metasurface 1030 and the free space air between the freeform optic 1050 and the metasurface 1030. The optical radiation 1005 is then refracted at the interface of the air and the first surface of the freeform optic 1050 (e.g., a rotationally symmetric spherical concave surface). The optical radiation 1005 is refracted again as it departs the second surface of the freeform optic 1050 into the air for free space transmission. The second surface of the freeform optic 1050 may be biconic, as described herein. The freeform optic 1050 expands the FOV in the steering direction 1090 to an expanded FOV that is between 160 and 210 degrees, according to various embodiments.

FIG. 10C illustrates an example optical layout of a metasurface 1030, a waveguide 1014, and a biconic freeform optic 1050, according to one embodiment. The freeform optic 1050 is suspended above the metasurface 1030 on top of the waveguide 1014, so additional supports (e.g., the supports 1055) are not needed. The laser assembly 1010 transmits optical radiation 1005 through an optical assembly that includes lens(es) 1011 into the waveguide 1014 (e.g., a reflective light guide) for total internal reflection and eventual incidence on the metasurface 1030. The metasurface 1030 steers the incident optical radiation 1005 in a steering direction 1090 within a metasurface FOV (a first FOV) based on the maximum steering angles for which the transmissivity is within a threshold transmittance value (e.g., 90%, 95%, or 99%).

The optical radiation 1005 is refracted at the interface between a transparent cover of the metasurface 1030 and the free space air. The optical radiation 1005 is then refracted at the interface of the air and the first surface of the freeform optic 1050 (e.g., a rotationally symmetric spherical concave surface or another concave surface). The optical radiation 1005 is refracted again as it departs the second surface of the freeform optic 1050 into the air for free space transmission. The second surface of the freeform optic 1050 may be biconic, as described herein. The freeform optic 1050 expands the FOV in the steering direction 1090 to an expanded FOV that is between 160 and 210 degrees, according to various embodiments.

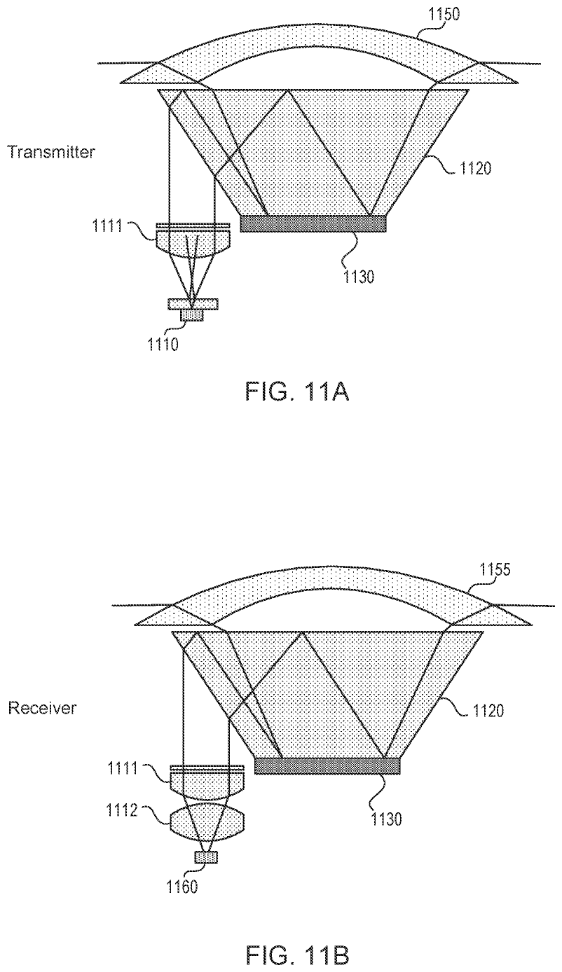

FIG. 11A illustrates a block diagram of a transmitter with a metasurface 1130 and a biconic freeform optic 1150 to steer optical radiation to steering angles with an expanded field of view (FOV), according to one embodiment. An optical radiation source 1110 transmits optical radiation through an optical assembly that includes lens(es) 1111 and/or prism(s) 1120. The metasurface 1130 steers the optical radiation within a metasurface FOV of less than a target FOV (e.g., less than 160 degrees). The biconic freeform optic 1150 operates to expand the FOV of the system such that the optical radiation can be selectively steered by the metasurface 110 for transmission within an expanded FOV of more than 160 degrees.

FIG. 11B illustrates a block diagram of a receiver with a metasurface 1130 and a biconic freeform optic 1155 to de-steer the optical radiation onto a detector 1160, according to one embodiment. The metasurface steers to a steering angle within a limited metasurface FOV for which the transmissivity is within a threshold transmittance value (e.g., 90%, 95%, or 99%). The biconic freeform optic 1155 operates to expand the FOV of the system such that the optical radiation can be steerably received at steering angles within an expanded FOV of more than 160 degrees. The received optical radiation is reflected by the prism 1120 for eventual refraction by lenses 1111 and 1112 and reception by a sensor array of the detector 1160.

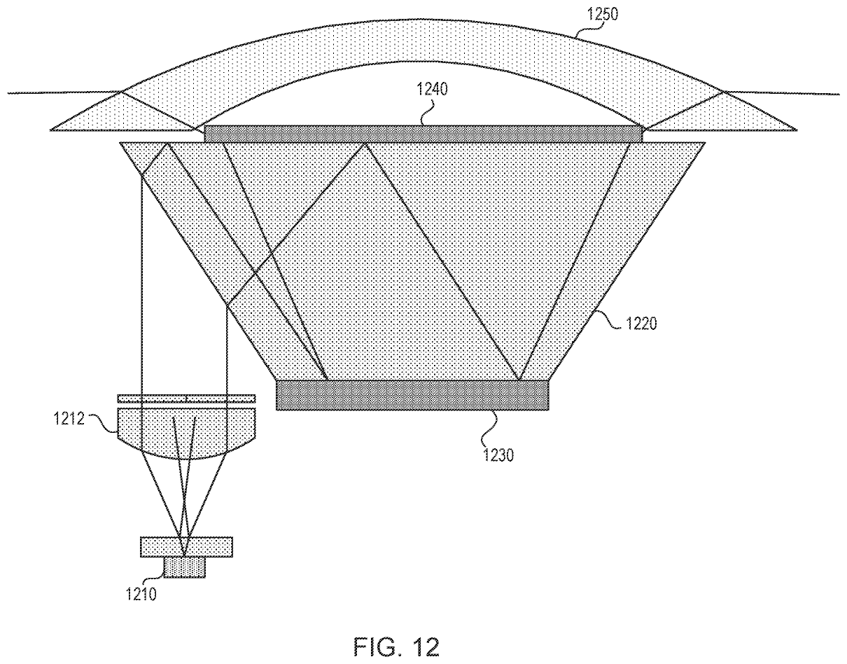

FIG. 12 illustrates a block diagram of a metasurface 1230 with a biconic freeform optic 1250 and an optical diffuser 1240 to modify the angular profile in the steering and/or non-steering direction, according to one embodiment. The optical diffuser 1240 (e.g., a lenslet array, diffractive optical element, metalens, etc.) may operate to tailor or otherwise modify the FOV or divergence profile of transmitted and/or received optical radiation. In some embodiments, the optical diffuser may tailor the angular profile of the optical radiation in only the non-steering direction. In other embodiments, the optical diffuser is also or alternatively configured to tailor the angular profile of the optical radiation in the steering direction. Optical radiation is transmitted by the laser assembly 1210 through lens(es) 1212 into the prism 1220. The optical radiation is ultimately reflected within the prism 1220 for incidence on and steering by the metasurface 1230. The steered optical radiation is conditioned or modified by the optical diffuser in the non-steering and/or steering direction prior to being further expanded by the biconic freeform optic.

According to various embodiments, any of the various biconic freeform optic devices and apparatuses may be fabricated using an injection molding plastic tool or other suitable manufacturing technique, depending on the material utilized. Suitable materials include but are not limited to, glass, sapphire, acrylics, plastics, and various transparent dielectric materials. The first and second surfaces of the biconic freeform optic may be cut on a metallic insert using a diamond point turning machine to create a mold. Injection molding can be used for a wide selection of available materials including, but not limited to, Cyclic olefin Polymer, Cyclic olefin copolymer, Acrylic, PMMA, Polycarbonate, Polyester, etc. In various embodiments, one or more surfaces of the biconic freeform optic 1250 may be coated with an AR coating to reduce reflections. In various embodiments, multiple freeform optics are used together (e.g., stacked or layered), at least one of which includes a biconic surface, to improve optical performance (e.g., expand a FOV, enhance a modulation transfer function (MTF) performance, etc.).

In some embodiments, a biconic freeform optic is fabricated with mechanical registering features (e.g., tabs, chamfers, pins, holes, etc.) to facilitate mounting the biconic freeform optic direction onto a prism, directly on a substrate around a metasurface, and/or directly onto an optically transparent cover of a metasurface. The mounting may create an air gap between the prism and the lower surface of the biconic freeform optic and/or an air gap between the metasurface and the biconic freeform optic.

The presently described embodiments support optical bandwidths and are, for example, suitable for optical sensing systems such as lidar, optical communications systems, optical computing systems, optical power transfer, and displays. For example, the systems and methods described herein can be configured with metasurfaces that operate in the sub-infrared, mid-infrared, high-infrared, and/or visible-frequency ranges (generally referred to herein as “optical” and understood in the context of feasibility and application). Given the feature sizes needed for sub-wavelength optical antennas and antenna spacings (e.g., sub-wavelength interelement spacings), the described metasurfaces may be manufactured using micro-lithographic and/or nano-lithographic processes, such as fabrication methods commonly used to manufacture CMOS integrated circuits.

This disclosure has been made with reference to various exemplary embodiments, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

1. An optical system, comprising:
a tunable optical metasurface that is selectively steerable in a steering direction to a plurality of steering angles; and
a biconic freeform optic positioned within an optical path of the metasurface, the freeform optic comprising:
a concave first surface positioned proximate to the metasurface, and
a biconic second surface that has a first radius of curvature along a first axis in the steering direction of the metasurface and a second radius of curvature along a second axis in a non-steering direction of the metasurface,
wherein the first radius of curvature along the first axis is different than the second radius of curvature along the second axis.

2. The optical system of claim 1, wherein the freeform optic is positioned relative to the metasurface with an air gap between the concave first surface of the freeform optic and the metasurface.

3. The optical system of claim 1, wherein the concave first surface of the freeform optic has a rotationally symmetric spherical radius of curvature.

4. The optical system of claim 1, wherein the concave first surface of the freeform optic has a rotationally symmetric conical radius of curvature.

5. The optical system of claim 1, wherein the concave first surface of the freeform optic comprises one of a biconic surface, a biconic Zernike surface, an extended polynomial surface, a Zernike polynomial surface, or a Chebyshev polynomial surface.

6. The optical system of claim 1, wherein the first and second radii of curvature are selected such that the biconic second surface corresponds to one of: a biconic Zernike surface, an extended polynomial surface, a Zernike polynomial surface, and a Chebyshev polynomial surface.

7. The optical system of claim 1, wherein the first and second surfaces of the freeform optic are shaped to compensate for one or more of: an optical distortion, a steering line width of the metasurface, and a steering asymmetry of the metasurface.

8. The optical system of claim 1, wherein the metasurface is selectively steerable within a first field of view (FOV) in the steering direction for which optical transmissivity is above a threshold transmittance value, and
wherein the first radius of curvature along the first axis in the steering direction of the metasurface is selected to expand the first FOV of the metasurface for which the optical transmissivity is above the threshold transmittance value to an expanded FOV.

9. The optical system of claim 8, wherein the threshold transmittance value is between 80% and 99%.

10. The optical system of claim 8, wherein the first FOV of the metasurface is between 100 degrees and 140 degrees, and wherein the expanded FOV provided by the freeform optic is between 140 degrees and 210 degrees.

11. The optical system of claim 1, wherein the freeform optic comprises a metalens formed on a curved substrate.

12. The optical system of claim 1, wherein the freeform optic comprises one or more of a diffractive optical element, a refractive optical element, and a reflective optical element.

13. The optical system of claim 1, further comprising:
an optical radiation source to generate optical radiation to be reflected by the metasurface for transmission through the freeform optic, wherein transmitted optical radiation is steered by the metasurface within a first field of view (FOV) in the steering direction and reflected by the metasurface with a second, fixed FOV in the non-steering direction.

14. The optical system of claim 13, further comprising:
a prism positioned between the metasurface and the freeform optic, wherein the prism is configured to deflect the optical radiation generated by the optical radiation source onto the metasurface.

15. The optical system of claim 13, wherein the first radius of curvature along the first axis in the steering direction is selected to expand the first FOV within which the metasurface selectively steers the optical radiation, and
wherein the second radius of curvature along the second axis in the non-steering direction is configured to expand the second, fixed FOV.

16. The optical system of claim 13, further comprising:
a controller to:
cause the optical radiation source to generate optical radiation, and
tune the metasurface to deflect incident optical radiation as output optical radiation steered at a target steering angle.

17. The optical system of claim 13, wherein the optical radiation source comprises one of:
a set of vertical-cavity surface-emitting lasers (VCSELs), and
a set of edge-emitting lasers.

18. The optical system of claim 1, further comprising:
an optical detector sensor to receive optical radiation reflected by the metasurface,
wherein the metasurface reflects optical radiation to the optical detector sensor that is received through the freeform optic at selective steering angles within a first field of view (FOV) in the steering direction and within a second, fixed FOV in the non-steering direction.

19. The optical system of claim 18, further comprising:
a prism positioned between the metasurface and the freeform optic, wherein the prism is configured to deflect the optical radiation generated reflected by the metasurface onto the optical detector sensor.

20. The optical system of claim 18, wherein the first radius of curvature along the first axis in the steering direction is selected to expand the first FOV within which the metasurface receives the optical radiation at selective steering angles, and
wherein the second radius of curvature along the second axis in the non-steering direction is configured to expand the second, fixed FOV.

21. An optical system, comprising:
a two-dimensionally steerable tunable optical metasurface that is selectively steerable in a first steering direction to a first plurality of steering angles within a first field of view (FOV) and selectively steerable in a second steering direction to a second plurality of steering angles within a second FOV; and
a biconic freeform optic positioned within an optical path of the metasurface, the freeform optic comprising:
a concave first surface positioned proximate to the metasurface, and
a biconic second surface that has a first radius of curvature along a first axis in the first steering direction of the metasurface and a second radius of curvature along a second axis in the second steering direction of the metasurface,
wherein the first radius of curvature along the first axis is different than the second radius of curvature along the second axis.

22. The optical system of claim 21, wherein the biconic second surface with the first and second radii of curvature is rotationally symmetric.

23. A light detection and ranging (lidar) transmitter, comprising:
a laser assembly to generate optical radiation;
a tunable optical metasurface to:
selectively steer incident optical radiation in a steering direction for transmission at a plurality of steering angles within a first field of view (FOV) in the steering direction for which the optical transmissivity is above a threshold transmittance value, and
transmit the optical radiation at each of the plurality of steering angles within a second, fixed FOV in a non-steering direction;
an optical assembly to convey the optical radiation generated by the laser assembly to the metasurface to be steered;
a controller to:
cause the laser assembly to generate optical radiation, and
tune the metasurface to steer incident optical radiation as a sequence of transmit scan lines at various steering angles within the first FOV; and
a biconic freeform optic positioned within an optical path of the metasurface, the freeform optic configured to expand the first FOV in the steering direction to an expanded FOV with an optical transmissivity above the threshold transmittance value, wherein the expanded FOV in the steering direction is larger than the first FOV.

24. The lidar transmitter of claim 23, wherein the freeform optic comprises a metalens formed on a curved substrate.

25. The lidar transmitter of claim 23, wherein the freeform optic comprises one or more of a diffractive optical element, a refractive optical element, and a reflective optical element.

26. The lidar transmitter of claim 23, wherein the freeform optic operates to deflect the sequence of transmit scan lines at the various transmit angles with an expanded, fixed FOV in the non-steering direction that is larger than the second, fixed FOV of the metasurface.

27. The lidar transmitter of claim 23, wherein the freeform optic operates to deflect the sequence of transmit scan lines at the various transmit angles without any change to the FOV in the non-steering direction, such the transmit scan lines are transmitted within the second, fixed FOV of the metasurface.

28. The lidar transmitter of claim 23, further comprising:
an air gap between the freeform optic and the metasurface.

29. The lidar transmitter of claim 23, wherein the freeform optic comprises:
a concave first surface positioned proximate to the metasurface, and
a biconic second surface that has a first radius of curvature along a first axis in the steering direction of the metasurface and a second radius of curvature along a second axis in a non-steering direction of the metasurface that is different than the first radius of curvature along the first axis.

30. The lidar transmitter of claim 29, wherein the concave first surface of the freeform optic has a rotationally symmetric spherical radius of curvature.

31. The lidar transmitter of claim 29, wherein the concave first surface of the freeform optic has a rotationally symmetric conical radius of curvature.

32. The lidar transmitter of claim 29, wherein the concave first surface of the freeform optic comprises one of a biconic surface, a biconic Zernike surface, an extended polynomial surface, a Zernike polynomial surface, or a Chebyshev polynomial surface.

33. The lidar transmitter of claim 29, wherein the first and second radii of curvature are selected such that the biconic second surface corresponds to one of: a biconic surface, a biconic Zernike surface, an extended polynomial surface, a Zernike polynomial surface, and a Chebyshev polynomial surface.

34. The lidar transmitter of claim 29, wherein the first and second surfaces of the freeform optic are shaped to compensate for one or more of: an optical distortion, a steering line width of the metasurface, and a steering asymmetry of the metasurface.

35. The lidar transmitter of claim 23, wherein the threshold transmittance value is between 80% and 99%.

36. The lidar transmitter of claim 23, wherein the optical assembly comprises one or more of a lens, a mirror, and a prism.

37. The lidar transmitter of claim 23, wherein the laser assembly comprises a set of vertical-cavity surface-emitting lasers (VCSELs).

38. The lidar transmitter of claim 37, wherein different subsets of the VCSELs are configured to be selectively activated to generate optical radiation for incidence on the metasurface at different angles of incidence in the non-steering direction, and
wherein the controller causes the laser assembly to generate optical radiation by selectively activating a subset of the VCSELs.

39. A light detection and ranging (lidar) receiver, comprising:
an array of detector elements to detect optical radiation as a received scan line;
a tunable optical metasurface that is steerable in a steering direction to:
reflect incident optical radiation to the array of detector elements at each of a plurality of receive steering angles within a first field of view (FOV) in the steering direction for which optical transmissivity is above a threshold transmittance value, and
reflect incident optical radiation to the array of detector elements at each of the plurality of receive steering angles within a second, fixed FOV in a non-steering direction;
an optical assembly to convey the optical radiation reflected by the metasurface to the array of detector elements;
a controller to tune the metasurface to receive optical radiation at a sequence of receive steering angles within the first FOV; and
a biconic freeform optic positioned within an optical path of the metasurface, the freeform optic configured to expand the first FOV in the steering direction to an expanded FOV with an optical transmissivity above the threshold transmittance value, wherein the expanded FOV in the steering direction is larger than the first FOV.

40. The lidar receiver of claim 39, wherein the freeform optic comprises a metalens formed on a curved substrate.

41. The lidar receiver of claim 39, wherein the freeform optic comprises one or more of a diffractive optical element, a refractive optical element, and a reflective optical element.

42. The lidar receiver of claim 39, wherein the freeform optic operates to reflect the incident optical radiation at the sequence of receive steering angles with an expanded, fixed FOV in the non-steering direction that is larger than the second, fixed FOV of the metasurface.

43. The lidar receiver of claim 39, wherein the freeform optic operates to reflect the incident optical radiation at the sequence of receive steering angles without any change to the FOV in the non-steering direction.

44. The lidar receiver of claim 39, further comprising:
an air gap between the freeform optic and the metasurface.

45. The lidar receiver of claim 39, wherein the freeform optic comprises:
a concave first surface positioned proximate to the metasurface, and
a biconic second surface that has a first radius of curvature along a first axis in the steering direction of the metasurface and a second radius of curvature along a second axis in a non-steering direction of the metasurface that is different than the first radius of curvature along the first axis.

46. The lidar receiver of claim 45, wherein the concave first surface of the freeform optic has a rotationally symmetric spherical radius of curvature.

47. The lidar receiver of claim 45, wherein the concave first surface of the freeform optic has a rotationally symmetric conical radius of curvature.

48. The lidar receiver of claim 45, wherein the concave first surface of the freeform optic comprises one of a biconic surface, a biconic Zernike surface, an extended polynomial surface, a Zernike polynomial surface, or a Chebyshev polynomial surface.

49. The lidar receiver of claim 45, wherein the first and second radii of curvature are selected such that the biconic second surface corresponds to one of: a biconic surface, a biconic Zernike surface, an extended polynomial surface, a Zernike polynomial surface, and a Chebyshev polynomial surface.

50. The lidar receiver of claim 45, wherein the first and second surfaces of the freeform optic are shaped to compensate for one or more of: an optical distortion, a steering line width of the metasurface, and a steering asymmetry of the metasurface.

51. The lidar receiver of claim 39, wherein the threshold transmittance value is between 80% and 99%.

52. The lidar receiver of claim 39, wherein the optical assembly comprises one or more of a lens, a mirror, and a prism.

53. The lidar receiver of claim 39, wherein the array of detector elements comprises a one-dimensional array of detector elements.

54. The lidar receiver of claim 39, wherein the array of detector elements comprises a two-dimensional array of detector elements.
